(19) United States
(12) Patent Application Publication
(10) Pub. No.: US 2015/0365362 A1
(43) Pub. Date: Dec. 17, 2015

(54) METHOD AND SYSTEM FOR REMINISCE AND VENERATE THE DECEASED

(71) Applicant: Good Ba Ba Technology Group Limited, Hong Kong (CN)

(72) Inventor: Se Kit Yuen, Hong Kong (CN)

(21) Appl. No.: 14/661,223

(22) Filed: Mar. 18, 2015

(30) Foreign Application Priority Data
Jun. 13, 2014 (HK) 14105640.7

(51) Int. Cl. H04L 12/58; A61G 99/00

(52) U.S. Cl. CPC H04L 51/046; A61G 99/00; H04L 51/02

(57) ABSTRACT

A method for commemoration of the deceased, includes receiving instruction that specify actions to be performed on a computer server to serve a request of a computing device; creating a temporary database having a subset of contents in data storage, creating a data exchange platform upon request by a service account of a user for manipulating the temporary database to perform intended commemoration operations, translating the instructions to a commemoration operation, initiating a chat session on the data exchange platform between two or more chat accounts, monitoring activities on the data exchange platform and the chat session, displaying information on the data exchange platform within a display window showing activities performed by one or more accounts on the data exchange platform, and displaying information within a chat window in the display window showing the chat session conducted between the two or more users; and a system for implementing the same.

The present invention relates to a method for reminiscing and venerating the deceased and a system of implementing the method.

### BACKGROUND OF THE INVENTION

There are many different types of memorial facilities for the livings to reminisce and venerate the deceased. Some of the examples are columbarium, cemetery, memorial wall, ancestral hall and the like.

A columbarium is a place for the respectful and usually public storage of urns containing the cremated remains of the deceased. The urns are normally stored within a plurality of storages walls. A columbarium can be built underground like those built in Roman Empire. Today's columbarium can be either free standing units, or part of a mausoleum or another facility. In some cases, columbarium is built into church structures like the Cathedral of our Lady of Angels in Los Angeles, Calif. In addition to Christianity, in Buddhism, ashes of the deceased may be placed in a columbarium (in Japanese Buddhism, a nokotsudo), which can be either attached to or a part of Buddhist temple or cemetery. This practice allows for the family of the deceased to visit the temple for the conduct of tradition memorials and ancestor rites. Scarcity of land has prompted the increase popularity of cremation especially for highly populated metropolitan city in Asia such as Tokyo, Hong Kong and etc. In Hong Kong, there are different proposal of building more columbarium, one example proposes building a large scale columbarium in one of the many outlaying islands. Another example proposes construction of a high rise columbarium building. Thus the columbarium can be of many different form and shapes.

A cemetery is an area where the remains of deceased people are buried or are otherwise interred. The remains may be interred in a grave, tomb, sarcophagus, a mausoleum, columbarium, or other edifice. Modern cemeteries often include crematoria, and memorial walls. At times, when the remains of deceased can not be found due to many reasons: casualty at war, disaster such as earthquake and tsunami, airplane crash at sea and etc.; thus plaque with name and some basic information of the deceased will be installed on the memorial walls.

Similar to memorial plaque on the memorial walls, in Asian countries, a wooden block with names of the ancestors presented as ancestral tablet is used. One reason of using ancestral tablet is that descendent can place ancestral tablet at home as a symbolization of having the soul of the deceased at home together with the family. Another very common practice is placing the tablets with the other ancestors inside an ancestral hall as a symbolization of re-union of all the deceased ancestors. Normally, the ancestral hall is located at the home town where the family originated from. There are times, memorial plaque or ancestral tablets are also placed in a shrine; a way for the soul of the deceased to be closer to holy land.

The memorial facility, whether for atheist or religious, in any form and size, is a place for the living to reminisce the deceased person. It is so important in human civilization to reminisce the deceased person that most country dedicate one national holiday each year for the living have time visiting the memorial facility to reminisce the deceased. For example there is the Memorial Day in U.S., Remembrance Sunday in U.K. Qing Ming Festival in China to name a few. Commemorate practice differs in different cultures and religious. For example, in Western countries, offering such as flowers are often placed and candles is burn in the memorial facility. In Asian countries, other offering such as food is often placed and incense is burn in the memorial facility. Some Asian countries will even burn imitated items that are made of paper such as, bank notes, houses and other goods as a way of sending the items to the deceased to use in the afterlife. For religious people, holy scripture are read and prayers are made. For atheist, poem or letters may be read out.

All these current practices are no doubt important as a way of reminisce and venerate the deceased. However, these practices have constraints in location, time, cost and etc. These practices also waste huge amount of natural resources create toxic pollution.

Whether in urban or rural areas, memorial facilities are normally located distance away from population center due to cost of land, environmental or religious (want to be a quiet place) reasons. In addition, with modern globalization, people often migrate to other countries or relocate to other cities; making frequent visits to the memorial facilities difficult if not impossible.

Furthermore, the busy work schedule of the descendants often makes them not able to visit the memorial facility on special days such as birthday, wedding anniversary and etc. of the deceased love ones. One day per year from the national holiday simply not enough, for descendants to fully pay tribute to the deceased.

Each year, large amount of money is spent in purchasing offerings and other veneration materials mentioned earlier. Most of the offerings will be trashed or burn after the veneration process. Although there is no consolidated figure, but it is estimated that billions of dollars has been spent on Qing Ming Festivals in China alone in one day. Also in Taiwan alone, two hundreds and eighty tons of paper-made offerings has been burn releasing at lease one hundred and eighty tons of carbon dioxide every year. Research carried out in Taiwan in 2001 links the burning of incense sticks to the slow accumulation of potential carcinogens in a poorly ventilated environment by measuring the levels of polycyclic aromatic hydrocarbons (including benzopyrene) within Buddhist temples.

In addition to the problems listed above, most of the current memorial facilities reveal limited information about the deceased such as name, time of living or with a photo at the most; making ancestor's history preservation difficult. This defeats another reason of veneration practice, educating the younger generation about the great good deeds of the ancestors while paying tribute to the ancestors. Many times, there is a fuzzy memory if any about the ancestors exists for the younger generation. In time, this will weakens the connection within a family; potentially break up the link in family.

There are traditional ways of commemorating the deceased but none teaches a complete environmental friendly solution of reminiscing and venerating the deceased while building stronger family link and overcome distance, time and language barrier at time same time.

The invention seeks to mitigate or at least alleviate such problems.

### SUMMARY OF THE INVENTION

There is provided a method for commemoration of the deceased, comprising: receiving, by a computer system, an instruction that specifies actions to be performed on a computer server to serve a request of a computing device; creating, by the computer system, a temporary database having subset of contents of a data storage; creating, by the computer system, a data exchange platform upon request by a service account of a user for manipulating the temporary database to perform intended commemoration operations; translating, by the computer system, the instruction to a commemoration operation; initiating, by the computer system, a chat session on the data exchange platform in response to a request to initiate a chat session between two or more chat accounts; monitoring, by the computer system, activities on the data exchange platform and the chat session; displaying, by the computer system, information on the data exchange platform within a display window showing activities performed by one or more service accounts on the data exchange platform; and displaying, by the computer system, information within a chat window in the display window showing the chat session conducted between the two or more chat accounts on the data exchange platform; wherein the method further comprising selecting a plan amongst a plurality of plans preset in the computing system, the preset plans contains instructions for performing specific actions on the data exchange platform and are displayed in the display window of the data exchange platform.

Preferably, translating the instructions to a commemoration operation comprises mapping the instructions to a commemorating activity to be displayed in the display window.

More preferably, the method further comprises compiling a list of chat service accounts in response to a request by the service account.

It is preferable that the method further comprising selecting a chat service account from the list of two or more chat service accounts.

Preferably, the method further comprising recording information displayed within a display window on the data exchange platform.

More preferably, the method further comprising indicators assigned to indicate the presence of corresponding users.

Yet more preferably, the method further comprising the step of customizing the computing device for providing instructions to the computer system specifying actions to be performed on the computer server to serve a request of the computing device;

Advantageously, the chat session includes any one of real time video chat, real time audio chat and real time messaging.

In another aspect of the invention there is provided a system for implementing the method mentioned above, the system comprising: a processor, an output device for displaying information; a memory communicatively connected with and readable by the processor and containing instructions that, when executed by the processor, cause the system to: receiving, by a computer system, instruction that specify actions to be performed on a computer server to serve a request of a computing device; creating, by the computer system, a temporary database having subset of contents of the data storage, creating, by the computer system, a data exchange platform upon request by a service account of a user for manipulating the temporary database to performing intended commemoration operations, translating, by the computer system, the instructions to a commemorating operation, initiating, by the computer system, a chat session on the data exchange platform in response to a request to initiate a chat session between two or more chat accounts, monitoring, by the computer system, activities on the data exchange platform and the chat session, displaying, by the computer system, information on the data exchange platform within a display window indicating activities performed by one or more account on the data exchange platform, displaying, by the computer system, information within a chat window in the display window indicating that the chat session is conducted between the two or more users.

It is preferable that the system further comprises an application installable to the computing device for customizing the computing device to provide instructions to the computer system specifying actions to be performed on the computer server to serve a request of the computing device

In another aspect of the invention there is provided a method for commemoration of the deceased, comprising: receiving, by a computer system, an instruction that specifies actions to be performed on a computer server to serve a request of a computing device; creating, by the computer system, a temporary database having subset of contents of a data storage; creating, by the computer system, a data exchange platform upon request by a service account of a first user; translating, by the computer system, the instruction to a commemorating operation; initiating, by the computer system, an invitation to a service account of a second user to enter the data exchange platform at a specified date and time, permitting access to the data exchange platform and the temporary database at the specified date and time for entering by the service accounts of the first and second users for manipulating the temporary database to perform intended commemoration operations.

Preferably, the creation of a data exchange platform for performing intended commemoration operations includes the step of creating at least two temporary databases having subset of contents of the data storage in relation to information of respective deceased person.

More preferably, the creation of the data exchange platform further includes the step of inviting two or more secondary service account of users to enter the data exchange platform.

Yet more preferably the method further comprising the steps of: initiating, by the computer system, a chat session on the data exchange platform in response to a request to initiate a chat session by the primary or secondary service account of a user, monitoring, by the computer system, activities on the data exchange platform and the chat session, displaying, by the computer system, information on the data exchange platform within a display window indicating activities performed by one or more account on the data exchange platform, displaying, by the computer system, information within a chat window in the display window indicating that the chat session is conducted between the two or more users.

In another aspect of the invention there is provided a system for implementing the method as claimed above, the system comprising: a processor, an output device for displaying information; a memory communicatively connected with an readable by the processor and containing instructions that, when executed by the processor, cause the system to: receiving, by a computer system, instruction that specify actions to be performed on a computer server to serve a request of a computing device; creating, by the computer system, a temporary database having subset of contents of the data storage, creating, by the computer system, a data exchange platform upon request by a primary service account of a user, translating, by the computer system, the instructions to an commemorating operation, initiating, by the computer system, an invitation to secondary service account of a user to enter the data exchange platform at a specified date and time, permitting access to the data exchange platform and the temporary database at the specified date and time for entering by the primary and secondary service account of users for manipulating the temporary database to performing intended commemoration operations.

In another aspect of the invention there is provided a method of creating a family tree for remote commemoration of the deceased, comprising: receiving, by a computer system, an instruction that specifies actions to be performed on a computer server to serve a request of a computing device; creating, by the computer system, a temporary database having subset of contents of a data storage; creating, by the computer system, a data exchange platform upon request by a service account of a user for manipulating the temporary database to perform intended commemoration operations; translating, by the computer system, the instruction to an commemorating operation; initiating, by the computer system, a family tree creating session on the data exchange platform in response to a request to initiate the family tree creating session by a service account; providing, by the computer system, access to a data store of information corresponding to the deceased comprising a plurality of data nodes, each data node representing data relating to a corresponding one member of the family, and a plurality of edges, each edge defining a connection between a corresponding pair of the nodes; determining, by the computer system, whether the connection between first and second nodes reflects a family relationship; generating, by the computer system, an indicator for each connection reflecting a family relationship, the indicator being based on the family relationship relative to the deceased; displaying, in an order according to the indicator, information of the corresponding member of the family; and arranging, by the computer system, the nodes in a family tree, with the arranged nodes connected according to the family relationship between the arranged nodes.

Preferably, the data store of information corresponding to the deceased comprising a plurality of secondary data nodes, each secondary data node representing data relating to a corresponding one member of the family member direct to the member represented by a primary node being direct family member to the deceased, and a plurality of secondary edges, each secondary edge defining a connection between a corresponding pair of the secondary nodes.

More preferably, the determining whether the connection represents a family relationship and the step of generating an indicator are reach performed based on analyzing and providing a weight to one or more of the following factors: a match of surnames between users corresponding to the node and any one of the secondary node; a match of a surname to middle name between users corresponding to the node and any one of the secondary node; gender of users corresponding to the node and any one of the secondary node, and relative ages of users corresponding to the node and any one of the secondary node.

It is advantageous that the method further comprises the steps of: receiving, by a computer system, an instruction from an account user to redefine each edge between a corresponding pair of the nodes based on the family relationship in relation to the account user; creating, by the computer system, a temporary database having subset of contents of a data storage; providing, by the computer system, access to the temporary database with information corresponding to the user comprising a plurality of data nodes, each data node representing data relating to a corresponding one member of the family to the user, and a plurality of edges, each edge defining a connection between a corresponding pair of the nodes; re-determining, by the computer system, whether the connection between first and second nodes reflects a family relationship to the user; re-generating, by the computer system, an indicator for each connection reflecting a family relationship, the indicator being based on the family relationship relative to the account user; displaying, in an order according to the indicator, information of the corresponding member of the family; and arranging, by the computer system, the nodes in a family tree, with the arranged nodes connected according to the family relationship between the arranged nodes.

It is preferable that the method further comprises the steps of: receiving, by a computer system, an instruction from an account user to selectively display a set of information in the family tree which relates to a particular bloodline; determining, by the computer system, whether each of the nodes reflects a family relationship in relation to a particular bloodline; creating, by the computer system, a temporary database containing the nodes that reflect a family relationship in relation to a particular bloodline and a plurality of edges, each edge defining a connection between a corresponding pair of the nodes; re-generating, by the computer system, an indicator for each connection reflecting a family relationship, the indicator being based on the family relationship relative to the account user or the deceased; displaying, in an order according to the indicator, information of the corresponding member of the family; and arranging, by the computer system, the nodes in a family tree, with the arranged nodes connected according to the family relationship between the arranged nodes.

Advantageously, the blood line comprises the father's blood line and/or the mother's blood line.

More advantageously, the family tree comprises a genealogy record.

In another aspect of the invention there is provided a system for implementing an interactive display of a family tree with family members and relationships between family members, the system comprising: a processor, a memory communicatively connected with an readable by the processor and containing instructions that, when executed by the processor, cause the system to creating, by the computer system, a temporary database having subset of contents of the data storage, creating, by the computer system, a data exchange platform upon request by a service account of a user for manipulating the temporary database to performing intended commemoration operations, translating, by the computer system, the instructions to an commemorating operation, initiating, by the computer system, a family tree creating session on the data exchange platform in response to a request to initiate the family tree creating session by a service account, providing, by the computer system, access to a data store of information corresponding to the deceased comprising a plurality of data nodes, each data node representing data relating to a corresponding one member of the family, and a plurality of edges, each edge defining a connection between a corresponding pair of the nodes, determining, by the computer system, whether the connection between first and second nodes reflects a family relationship, generating, by the computer system, an indicator for each connection reflecting a family relationship, the indicator is based on the family relationship relative to the deceased, displaying, in an order according to the indicator, information of the corresponding member of the family, arranging, by the computer system, the nodes in a family tree, with the arranged nodes connected according to the family relationship between the arranged nodes.

### BRIEF DESCRIPTION OF DRAWINGS

The invention will now be more particularly described, by way of example only, with reference to the accompanying drawings, in which:

FIG. 1 illustrates exemplary user interface for entering the system;

FIG. 2 illustrates exemplary user interface for logging into with the system;

FIG. 3 illustrates exemplary user interface for registration with the system;

FIG. 4 illustrates exemplary user interface for using the family tree;

FIG. 5 illustrates exemplary user interface for using the family tree;

FIG. 6 illustrates exemplary user interface for editing the family tree;

FIG. 7 illustrates exemplary user interface for displaying and manipulating a personalized page of a deceased;

FIG. 8 illustrates exemplary user interface for showing a timeline in relation to the life of the deceased;

FIG. 9 illustrates exemplary user interface for accessing personalized photo albums in relation to the deceased;

FIG. 10 illustrates exemplary user interface for accessing personalized video albums in relation to the deceased;

FIG. 11 illustrates exemplary user interface for accessing personalized audio albums in relation to the deceased;

FIGS. 12 and 13 are diagrams illustrating the interface showing messages from the deceased to his friends and family;

FIG. 14 illustrate exemplary user interface showing messages from the friends and family of the deceased;

FIG. 15 illustrates exemplary user interface for booking a facility in the system;

FIGS. 16 to 18 illustrate exemplary user interface for setting up a commemoration gathering;

FIG. 19 illustrates exemplary user interface for commemorating the deceased in a commemoration gathering;

FIG. 20 is a diagram showing a number of payment plans for payment of commemorating the deceased by making use of the system;

FIG. 21 illustrates exemplary user interface for commemorating a number of the deceased in a commemoration gathering;

FIG. 22 illustrates exemplary display of a reminder for an upcoming commemoration gathering;

FIG. 23 illustrates exemplary display of a user guide;

FIG. 24 illustrates exemplary user interface for commemorating public figures;

FIG. 25 illustrates exemplary display of an introduction of the system;

FIG. 26 illustrates exemplary display of other information provided by the system;

FIG. 27 is a diagram illustrating a display on a mobile phone installed with an application specifically designed for the permitting implementation of the method on the mobile phone, showing a login page;

FIG. 28 illustrate exemplary user interface for registration with the system;

FIG. 29 illustrate exemplary user interface for selecting various functions available made by the system;

FIG. 30 illustrate exemplary user interface for showing a personalized page of a deceased with information stored in the data storage of the system;

FIG. 31 illustrate exemplary user interface for showing a commemoration gathering, in operation, commemorating three of the deceased;

FIG. 32 is a diagram illustrating the display in FIG. 31 showing a list of signed in service account users attending the commemoration gathering;

FIG. 33 is a diagram illustrating the display in FIG. 31 showing a chat session between two service account users in a chat display; and

FIGS. 34 and 35 illustrate exemplary user interface for using a family tree in accordance with some embodiment;

### DETAILED DESCRIPTION OF PREFERRED EMBODIMENT

According to a first aspect of the invention, there is provided a method for remote commemoration of the deceased. The method is implemented through a computer system connectable with one or more local or remote computing devices by a secured network accessible through the WWW.

According to the second aspect of the invention, there is provided a system for implementing the method as mentioned above and as detailed in the later part of the specification.

The computer system has a computer server including a processor and a memory communicatively connected with and readable by the processor. The memory includes a data storage that contains information of one or more deceased persons. The information is divided into subsets of contents of the data storage one for each deceased person created, accessible and editable by a primary service account of user(s).

A part of the computer system may be provided at a designated location. This part of the computer system includes a local computing device connected to the server for access by a service account of user at the designated location. Function rooms are provided at the designated location for accommodating a group of service accounts of users or a service account of user and his/her guest for commemoration of one or more deceased.

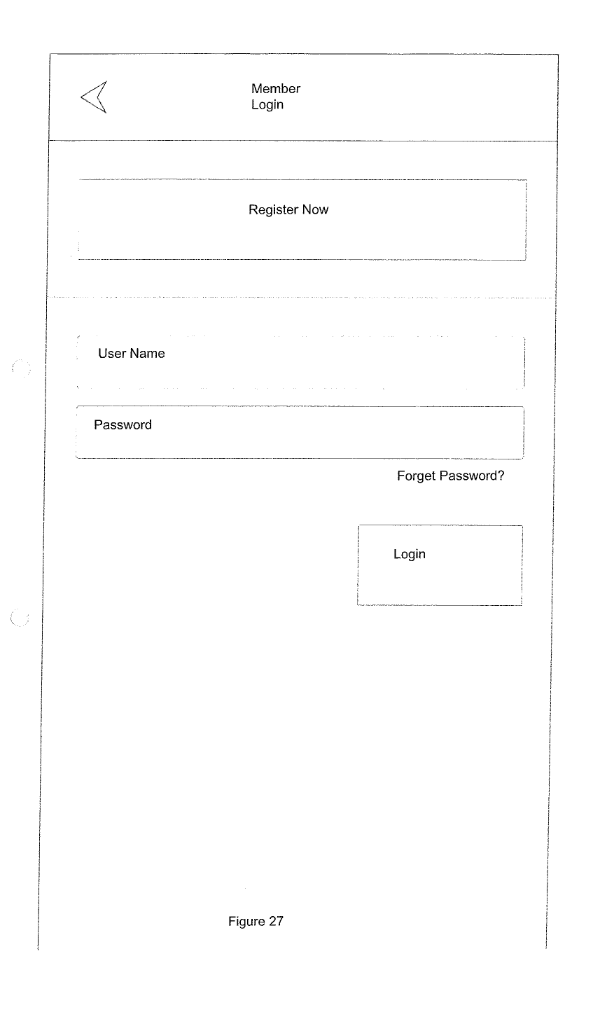

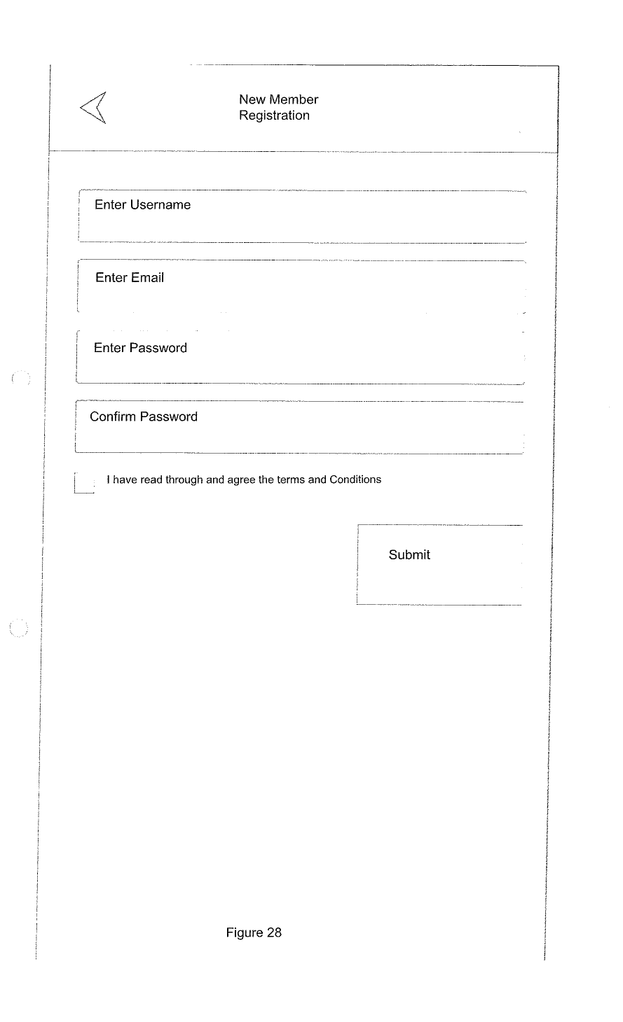

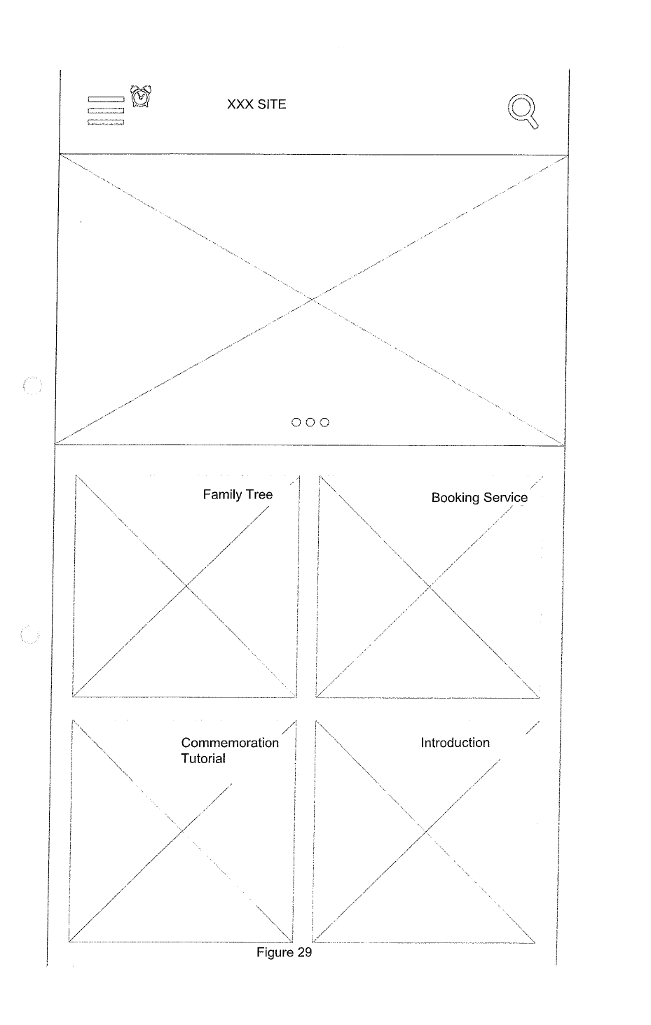

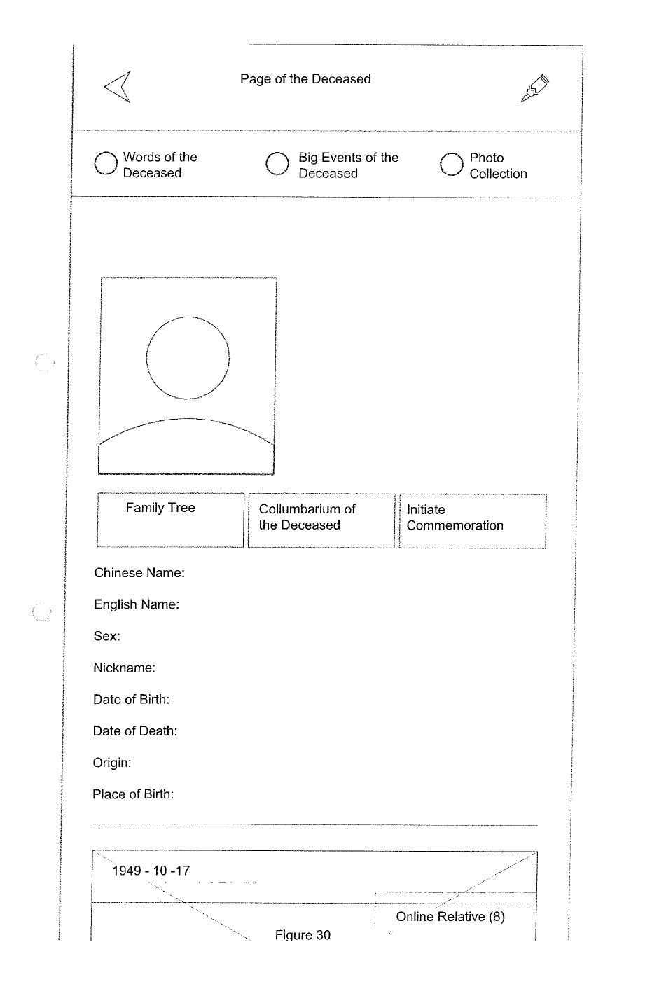

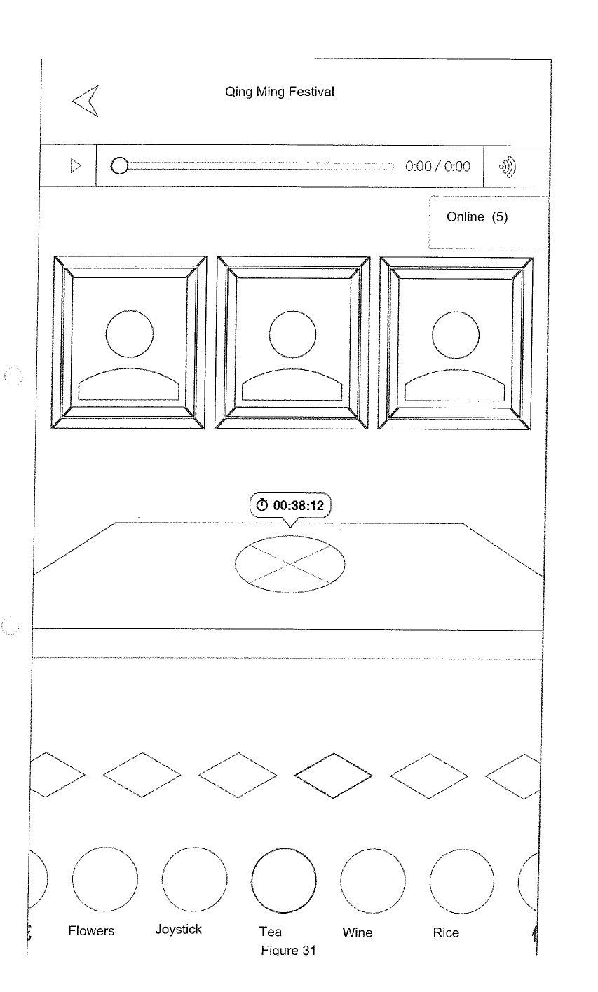

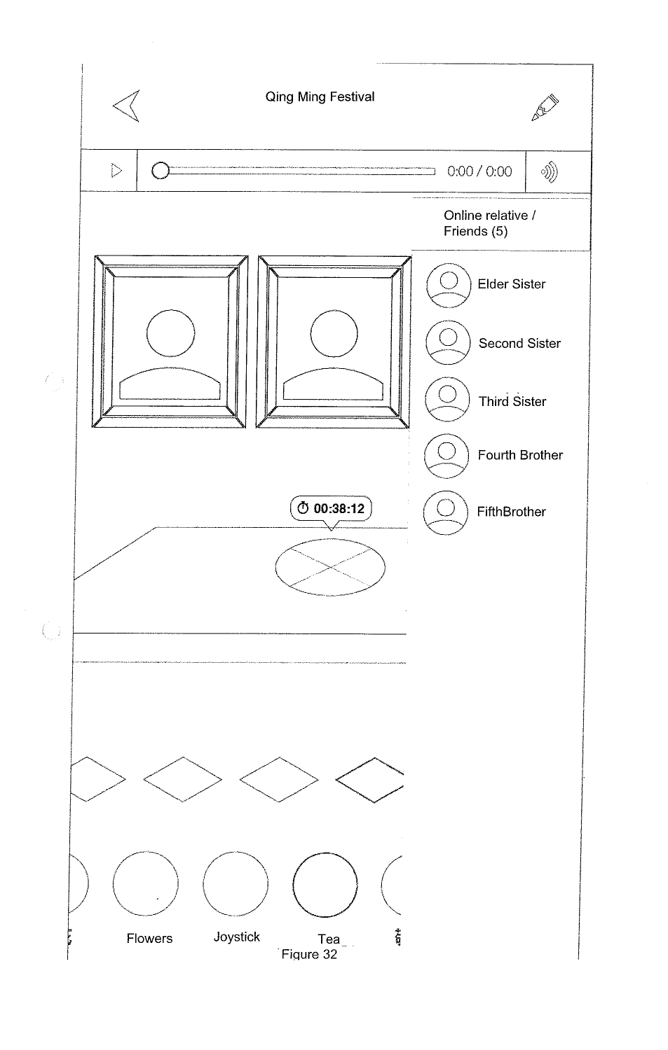

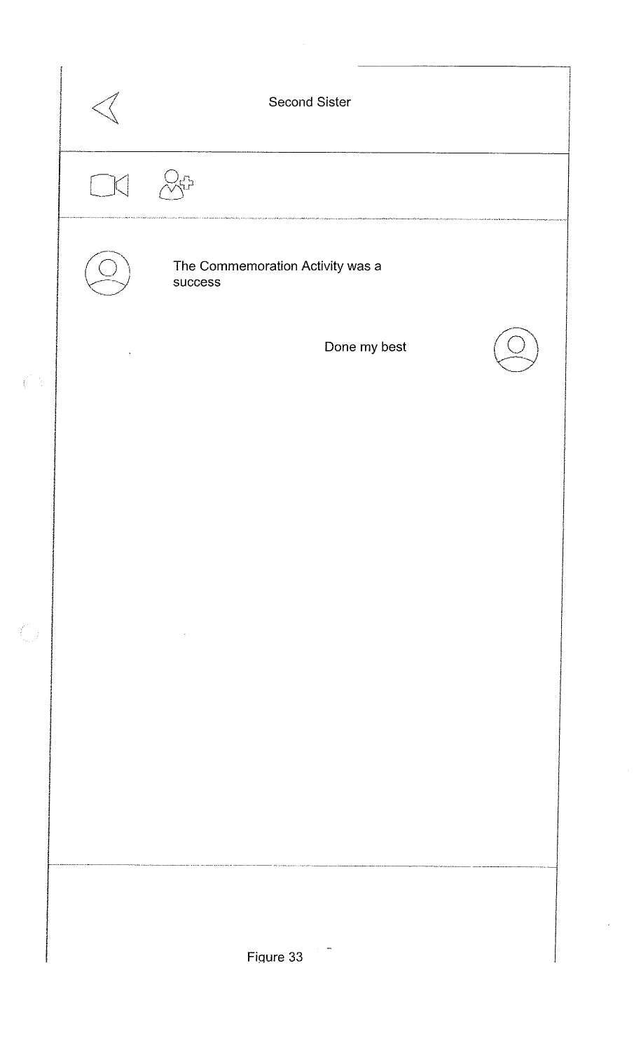

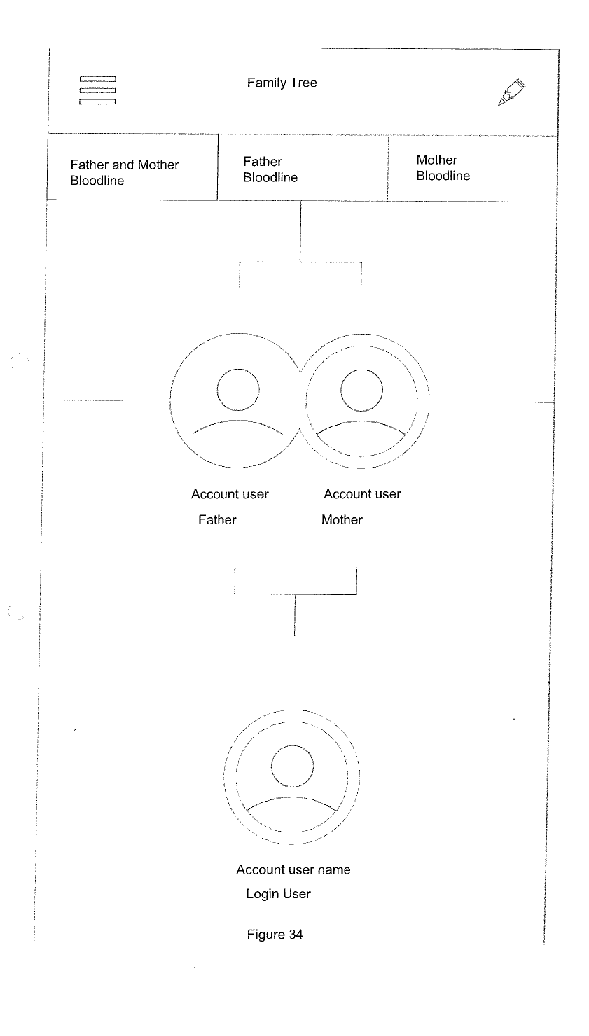

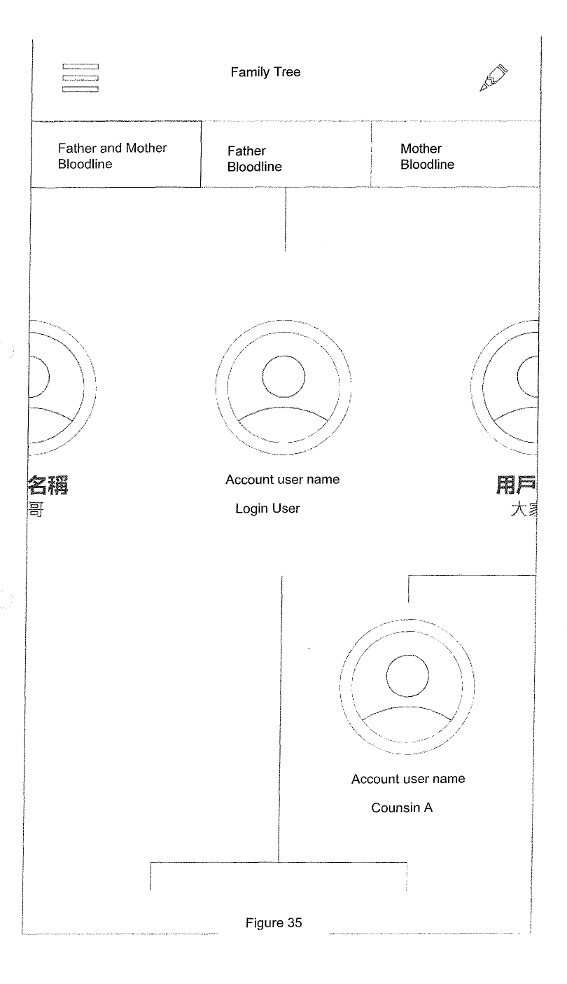

The local or remote computing device is customizable by the user for joining as part of the computer system. The computing device may be any third party devices including but not exclusively of mobile phone, ipad, laptop or any desktop. The customization of the computing device may be an application specifically designed for installing on the computing device permitting the establishment of a secured connection with the server in the computing system. The local or remote computing devices may include one or more outputs for displaying images, video or sound outputs in a human perceivable format. The customized computing device will be able to allow manipulation of the computer system and the commemoration methods made available by the computer system through the third party device, as shown in FIGS. 27 to 35.

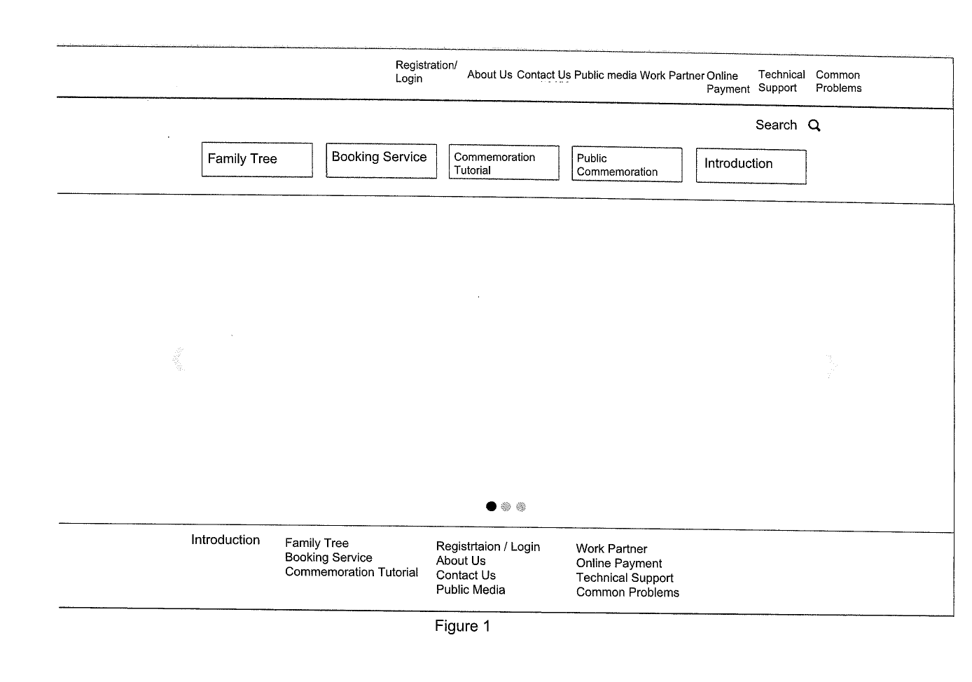

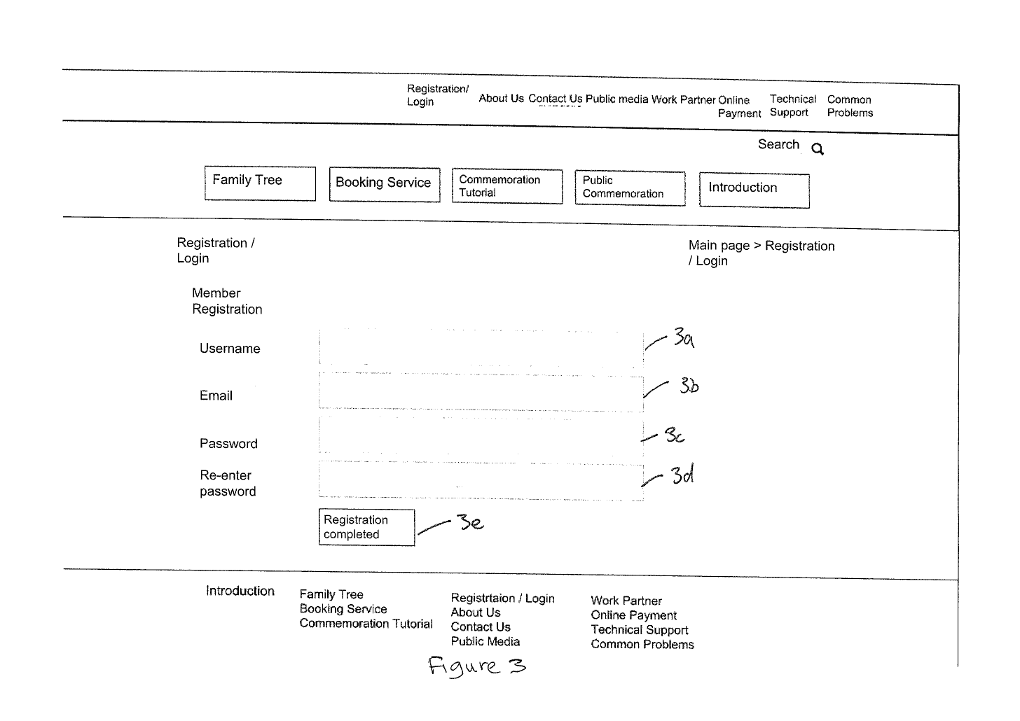

The method involves registering one or more primary service account user with the system. An account creation platform for entering relevant information to create a primary service account is showed in FIG. 3 accessible through the interface as showed in FIG. 1. The account creation platform includes an account creating page permitting the entering of information such as the user name 3a, email address 3b, password 3c and password confirmation 3d. By entering this information and pressing the registration button 3e, a primary service account is created.

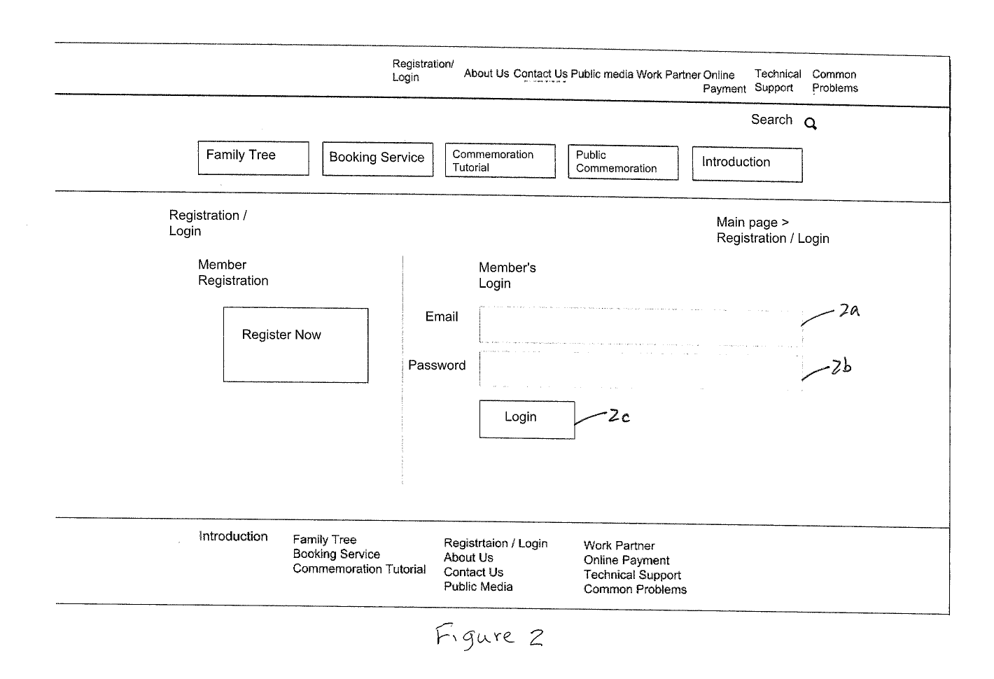

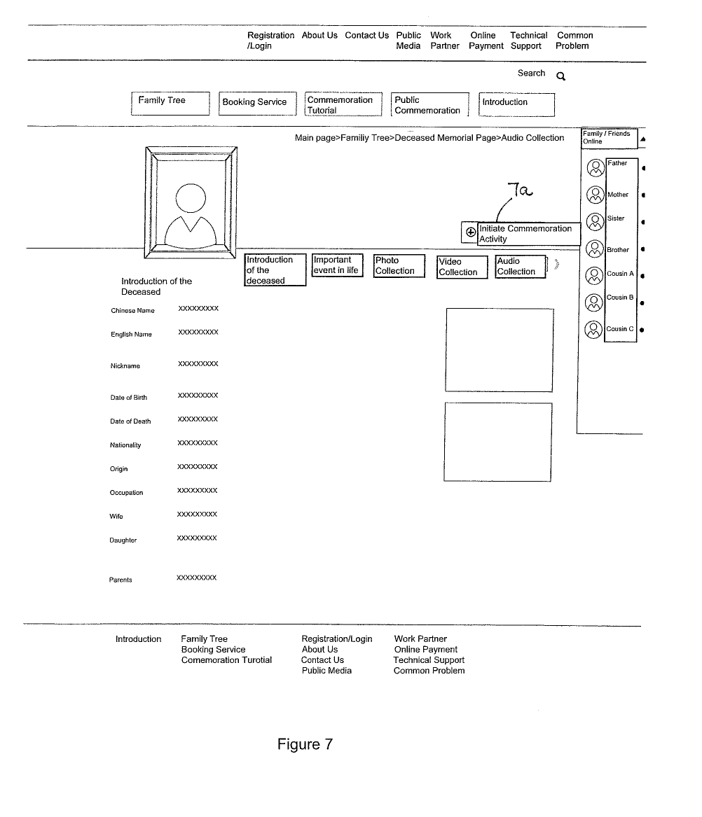

Once a primary service account is created, the user of the primary service account may log into the computer system for creating and constructing a customized page for a deceased. A login page as shown in FIG. 2 is accessible through the interface as shown in FIG. 1. A registered primary service account user may enter the system by entering the pre-registered email in space 2a and corresponding password in space 2b and pressing an enter button 2c. The creating and construction of a customized page for a deceased may involve uploading a picture of the deceased onto the data storage of the system and requesting the picture be shown on the customized page and designing the layout of the customized page. The customized pages as shown in FIGS. 7 to 14 may include various buttons for accessing different functions offered by the computer system.

Secondary service accounts may be created under the umbrella of the primary service account and in the same way as a primary service account. However it will not be given the authority to edit the data exchange platform of a deceased.

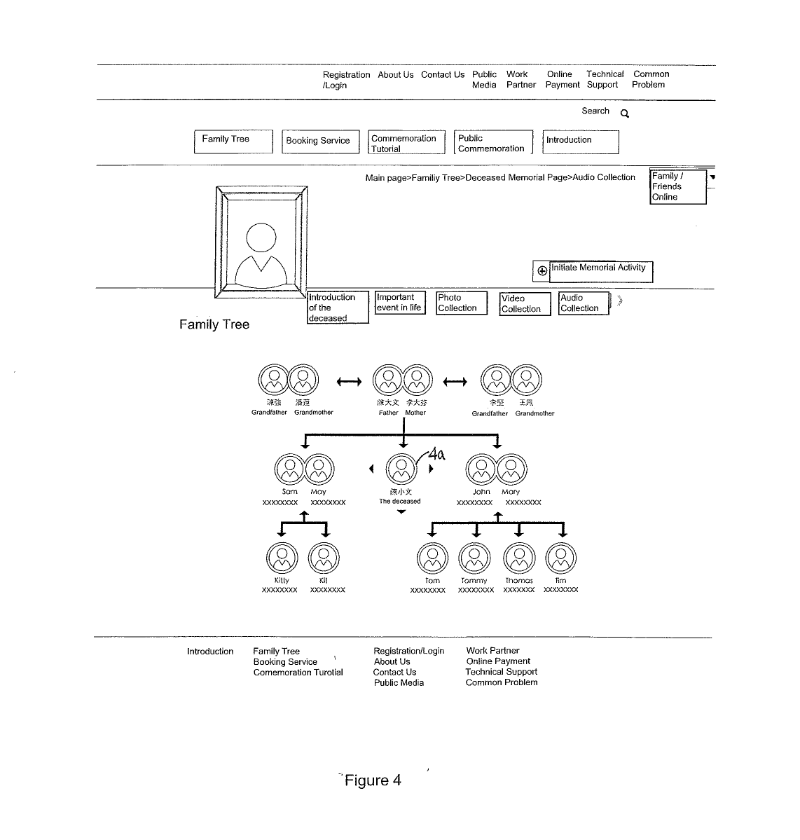

By logging into the system, a service account user may access a family tree of the deceased as shown in FIG. 4 by pressing a family tree button 4a. The primary service account user may manipulate the information displayed on a family tree page as shown in FIG. 4 while the secondary service account user may only view the information provided therein.

When the user enters the family tree session after entering the page or platform of a deceased, the family tree displayed is that compiled based on the family relationship relative to the deceased. The user will be indicated as “Me” but the relationships/edges will not be established based on the user, as shown in FIG. 4.

A button 4a is created for the deceased permitting access to the information of the deceased by any service account of user, including primary and secondary service account of user.

In more detail, after a primary service account is created, the user of the primary service account may access the computer system and the customized page for creating the family tree. This involving receiving, by the computer system, requesting that specify actions, the creation of a family tree, to be performed on the computer server to serve the request of a computing device, followed by the step of creating, by the computer system, a temporary database having subset of contents of the data storage. This temporary database permits editing and addition of new information into the data storage. Creating, by the computer system, a data exchange platform upon request by a service account of a user for manipulating the temporary database. This data exchange platform allows the primary service account of user to enter information into the temporary database and the data storage. Initiating, by the computer system, a family tree creating session on the data exchange platform in response to a request to initiate the family tree creating session by a primary service account. Entering information of the deceased, his/her relatives and friends through the data exchange platform to the subset of data of the deceased. Providing, by the computer system, access to the subset of data storage of information corresponding to the deceased. Generating a plurality of data nodes one for the deceased and one for each of the family member to be listed in the family tree. A node may also be generated for each of the friends entered. Each of these data nodes representing data relating to a corresponding one member of the family or a friend to the deceased. Generating a plurality of edges, each edge defining a connection between a corresponding pair of the nodes. Determining, by the computer system, whether the connection between first and second nodes reflects a family relationship to the deceased. Generating, by the computer system, an indicator for each connection reflecting a family relationship, the indicator is based on the family relationship relative to the deceased. Generating an indicator for each of the node based on analyzing and providing a weight to one or more of the following factors:

a match of surnames between users corresponding to the node and any one of the secondary node;

a match of a surname to middle name between users corresponding to the node and any one of the secondary node;

gender of users corresponding to the node and any one of the secondary node, and

relative ages of users corresponding to the node and any one of the secondary node.

Displaying, in an order according to the indicator, information of the corresponding member of the family and arranging, by the computer system, the nodes in a family tree, with the arranged nodes connected according to the family relationship between the arranged nodes.

The nodes created may be categorized into primary, secondary, tertiary nodes etc.

The primary nodes denote a direct family member to the deceased. The secondary node denotes family member that may be direct family member to the person assigned with a primary node. A plurality of secondary edges may be generated following the generating of the secondary nodes. Each secondary edge defines a connection between a corresponding pair of the secondary nodes.

The family tree comprises a genealogy record which is a study of families and the tracing of their lineages and history. It may make use of information obtained in oral interviews, historical records, genetic analysis and other records to demonstrate kinship and pedigrees of the family members. The results are often displayed in charts such as a family tree diagram.

Once the nodes and edges are calculated and established, the family tree can be manipulated by a primary or secondary user for making himself or herself as the node based on which the edges are recalculated. The recalculated edges and the respective nodes are displayed on the same family tree but based on the user.

In a preferred embodiment, when the user enters the family tree after login without entering a platform of a deceased, it sends an instruction to the computer system. The instruction specifies a user to be the person based on which the edges are to be recalculated.

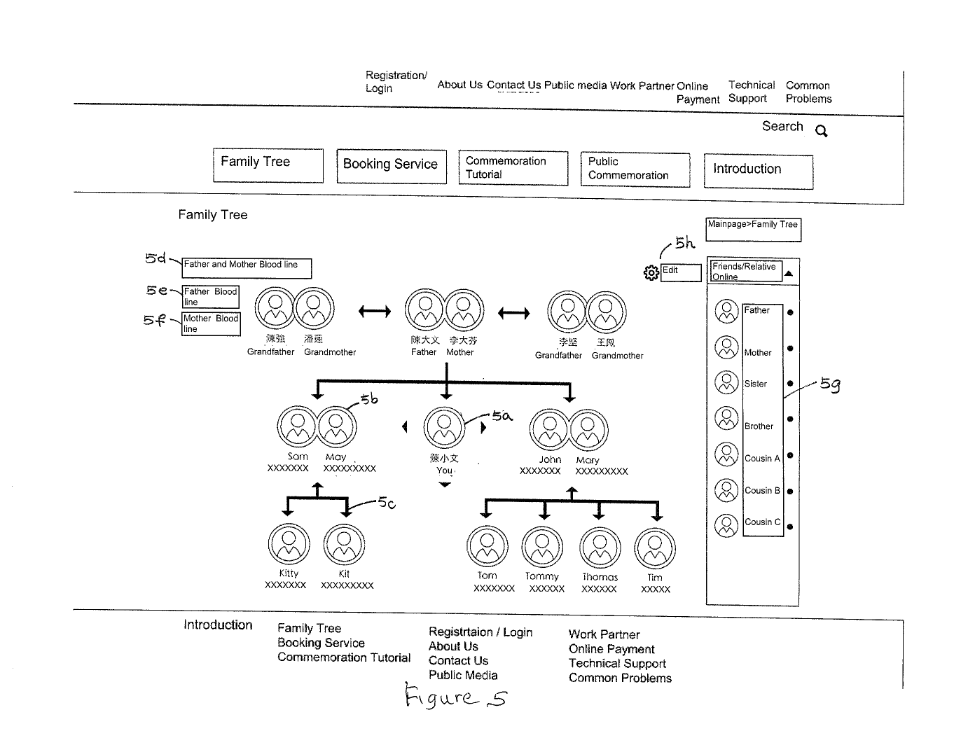

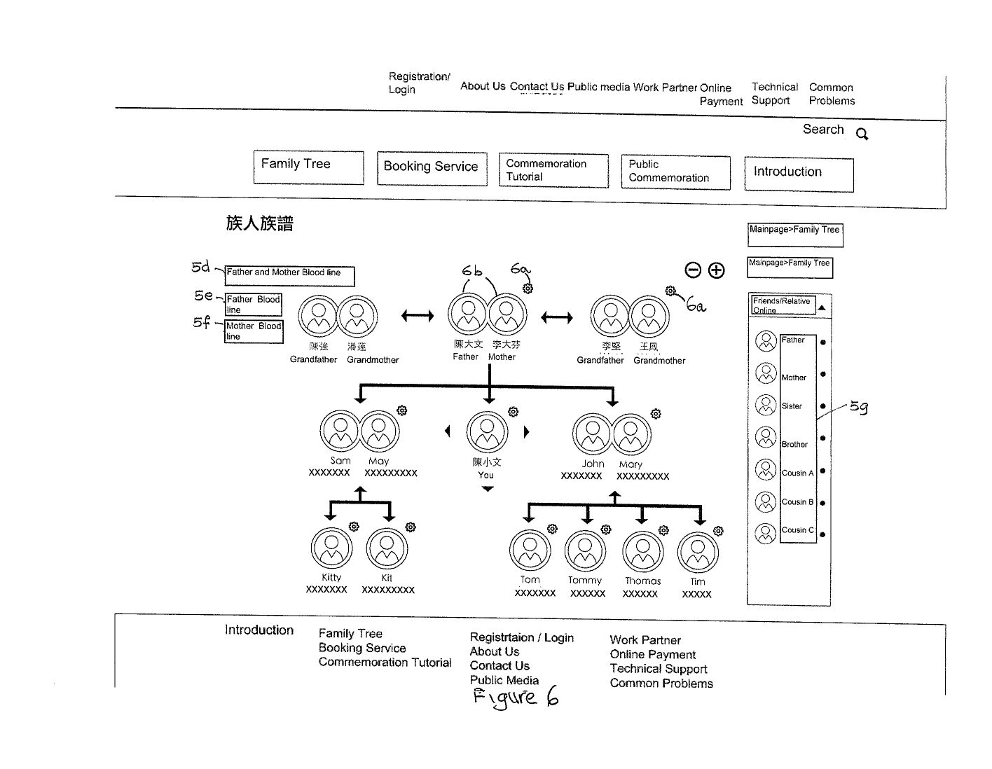

In more detail, the computer system receives the instruction from an account user to redefine each edge between a corresponding pair of the nodes based on the family relationship in relation to the account user; the computer system creates a temporary database having subset of contents of a data storage; the computer system provides access to the temporary database with information corresponding to the user comprising a plurality of data nodes, each data node representing data relating to a corresponding one member of the family to the user, and a plurality of edges, each edge defining a connection between a corresponding pair of the nodes; the computer system then re-determines whether the connection between first and second nodes reflects a family relationship based on the user; the computer system re-generates an indicator for each connection reflecting a family relationship, the indicator being based on the family relationship relative to the account user; information of the corresponding member of the family is displayed in an order according to the indicator; and the computer system arranges the nodes in a family tree, with the arranged nodes connected according to the family relationship between the arranged nodes. The node of the user will be indicated as “Me” and all edges/relationships are establishing based on the user. This is shown in FIGS. 5 and 6.

A list 5g of account users family to the account user is provided in the window displaying the family tree. The list is complied by the computer system including an icon and the name of the service account of user logged into the system. The family tree displaying on any one of the account users' computing device indicates the user's position 5a in the family tree as “Me”. This is made possible by identifying, by the computer system, the account user, creating an indicator for indicating and identifying each account user logged in and assigning respective indicator to the relevant service account of user.

As shown in FIG. 5, buttons may be generated for each of the primary and secondary nodes 5b and 5c. Clicking of one of the button take the user of the service account to detailed information about the family member denoted by the corresponding node. Editing of the information is restricted to primary service account user. A button 5h is available for editing the information in the family tree. By pressing the button 5h will either leads to the family tree editable page as shown in FIG. 6 for a primary service account of user or leads to the login page as shown in FIG. 3 if the user pressing the button 5h is not a primary service account of user.

As shown in FIG. 6, when the primary service account of user accessed the family tree page, the system recognizes the status of the user as a primary service account of user by mapping the login name and password with those pre-entered into the system. The pre-entered information was given a tag, upon registration, indicating the status of the user to which the information belongs.

A button 6a for editing is available adjacent a set of buttons assigned to each of the member 6b in the family tree. By pressing the button 6a leads to the individual page of the corresponding family member for editing.

In the family tree, at least the name, relationship and photo of the family member are displayed. By clicking the button 6b of the corresponding family member may lead to customized page of that member providing detailed information of the member.

As shown in FIGS. 5 and 6, a set of buttons 5d, 5e and 5f are provided. Each of these buttons 5d, 5e and 5f identifies a specific blood line. For example by clicking the button 5d, an instruction requiring the display of a particular blood line, for example the father and mother blood lines, is received by the computer system; the computer system then removes any node and edge not belonging to the father or mother blood line such that the family tree shows only the particular blood line. By clicking the button 5e, an instruction requiring the display of the father's blood line exclusively is received by the computer system, the computer system then remove any node and edge not belong to the father blood line such that the family tree shows only the father blood line. By clicking the button 5f, an instruction requiring the display of the mother's blood line exclusively is received by the computer system, the computer system then remove any node and edge not belonging to the mother's blood line such that the family tree shows only the mother's blood line.

The method involves the steps of receiving, by a computer system, an instruction from an account user to selectively display a set of information in the family tree which relates to a particular bloodline; determining, by the computer system, whether each of the nodes reflects a family relationship in relation to a particular bloodline; creating, by the computer system, a temporary database containing the nodes that reflect a family relationship in relation to a particular bloodline and a plurality of edges, each edge defining a connection between a corresponding pair of the nodes; re-generating, by the computer system, an indicator for each connection reflecting a family relationship, the indicator being based on the family relationship relative to the account user or the deceased; displaying, in an order according to the indicator, information of the corresponding member of the family; and arranging, by the computer system, the nodes in a family tree, with the arranged nodes connected according to the family relationship between the arranged nodes.

In another embodiment of the invention there is provided a method to commemorate the deceased includes the following steps:

Clicking the button corresponding to the deceased, receiving, by a computer system, instruction that specify actions to be performed on a computer server to serve a request of a computing device; Creating, by the computer system, a temporary database having subset of contents of the data storage, creating, by the computer system, a data exchange platform upon request by a service account of a user for manipulating the temporary database to performing intended commemoration operations, translating, by the computer system, the instructions to a commemorating operation.

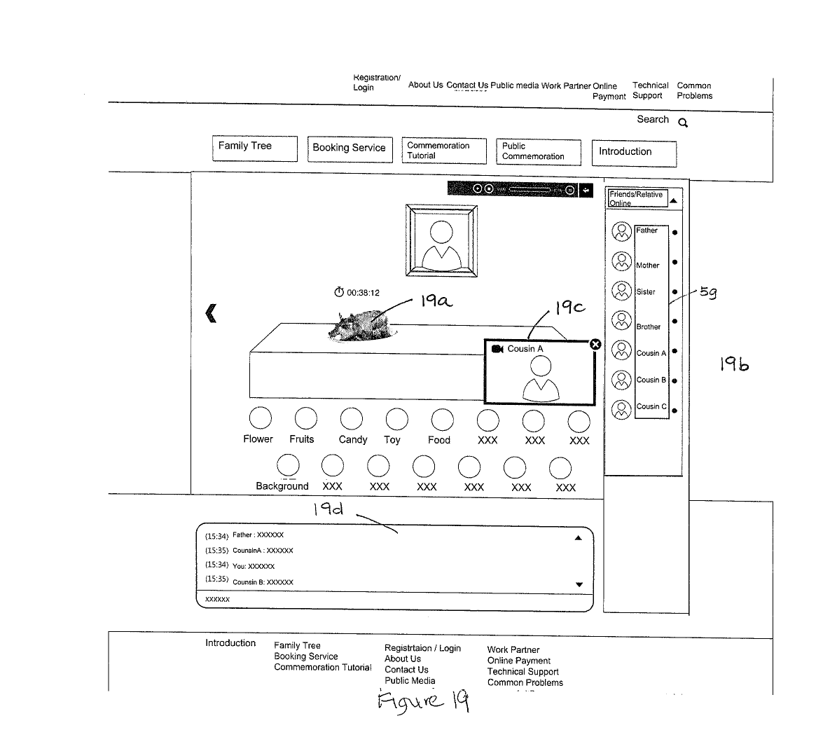

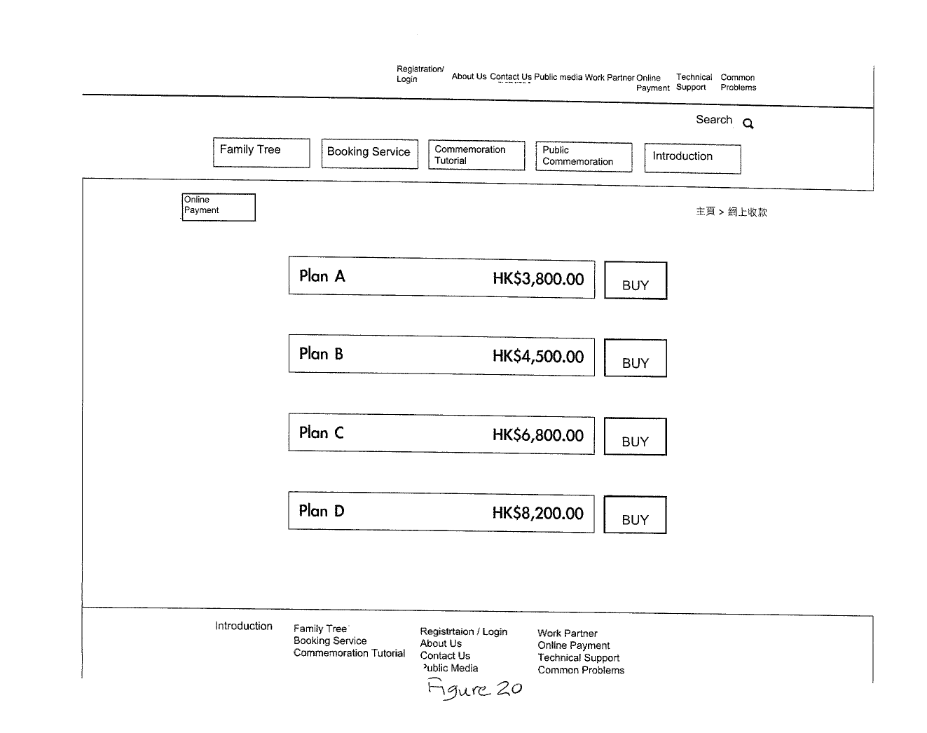

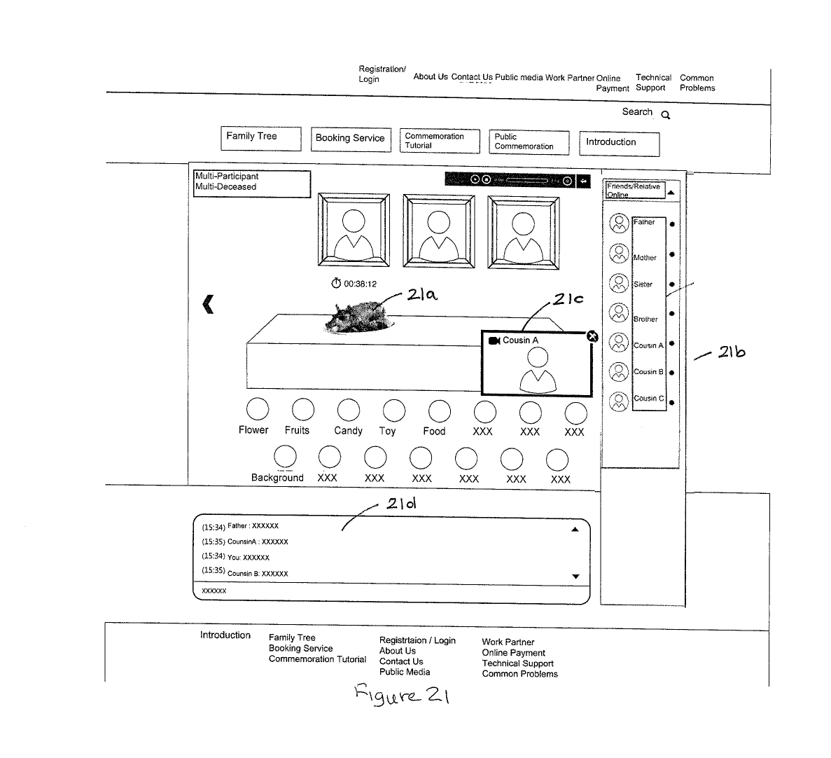

Commemoration of the deceased may be performed on the data exchange platform. Referring to FIGS. 19 and 21, various activities may be conducted virtually by the service account user by clicking activity buttons available on the data exchange platform. This may include presenting virtue gifts and flowers to the deceased. The commemorating operation comprises mapping the instructions to the commemorating activity to be displayed in the display window. The performance of the activity is viewable from the display window through a computing device output.

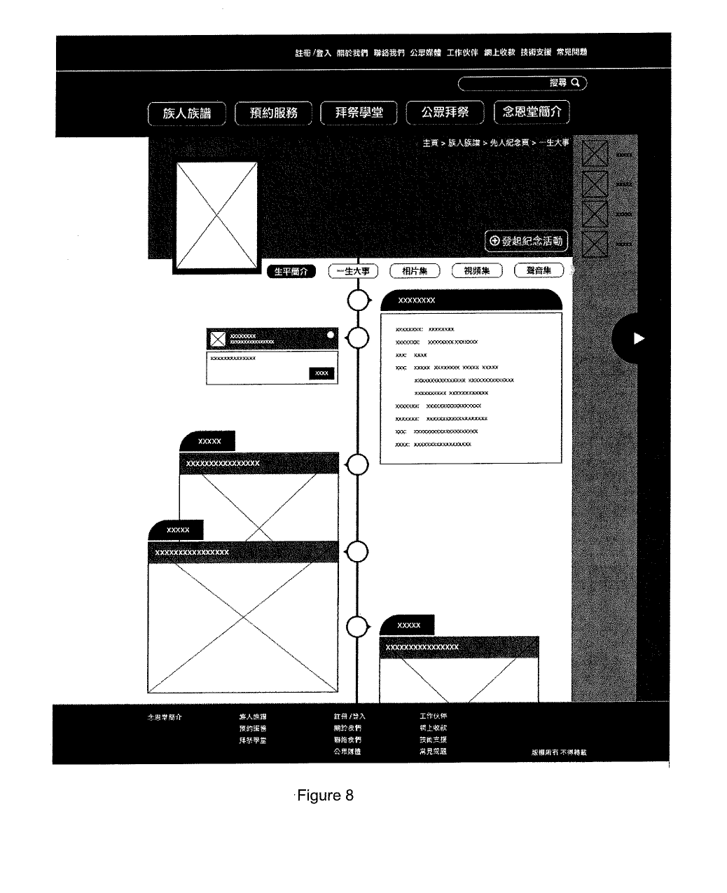

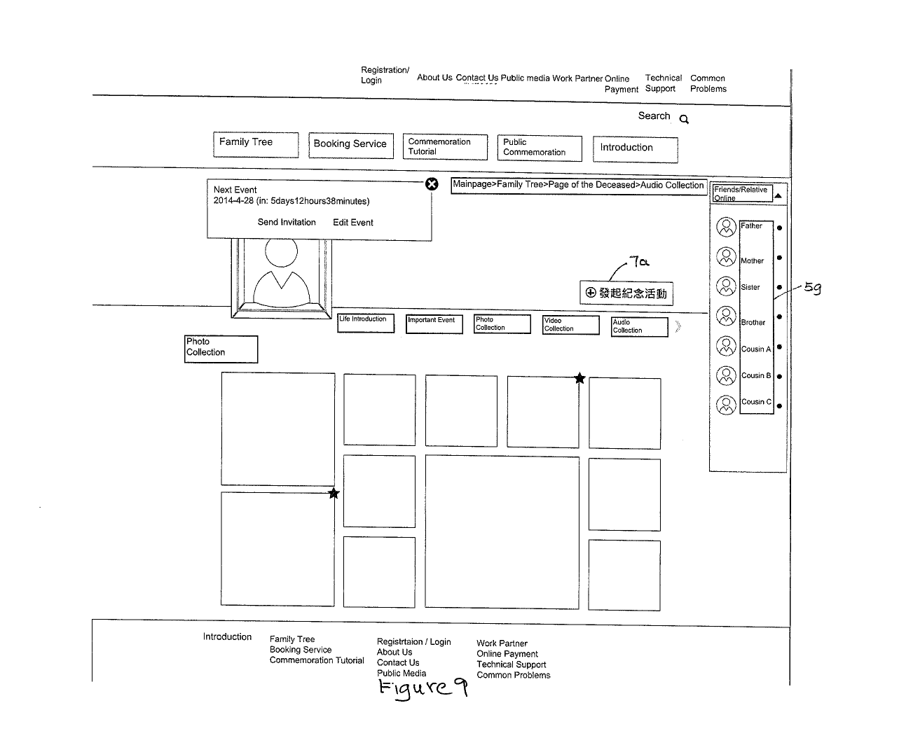

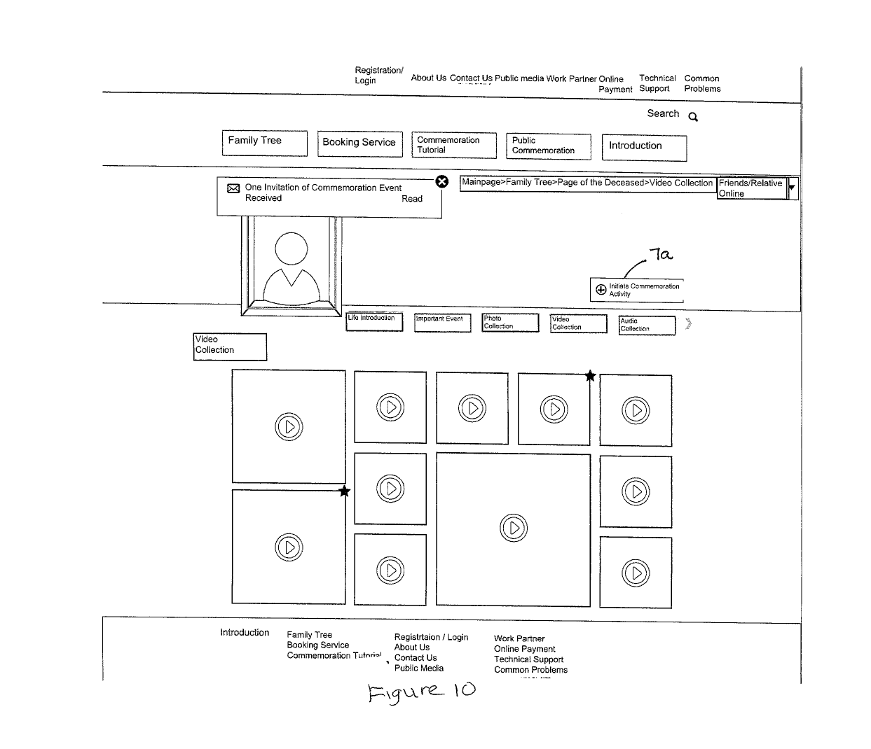

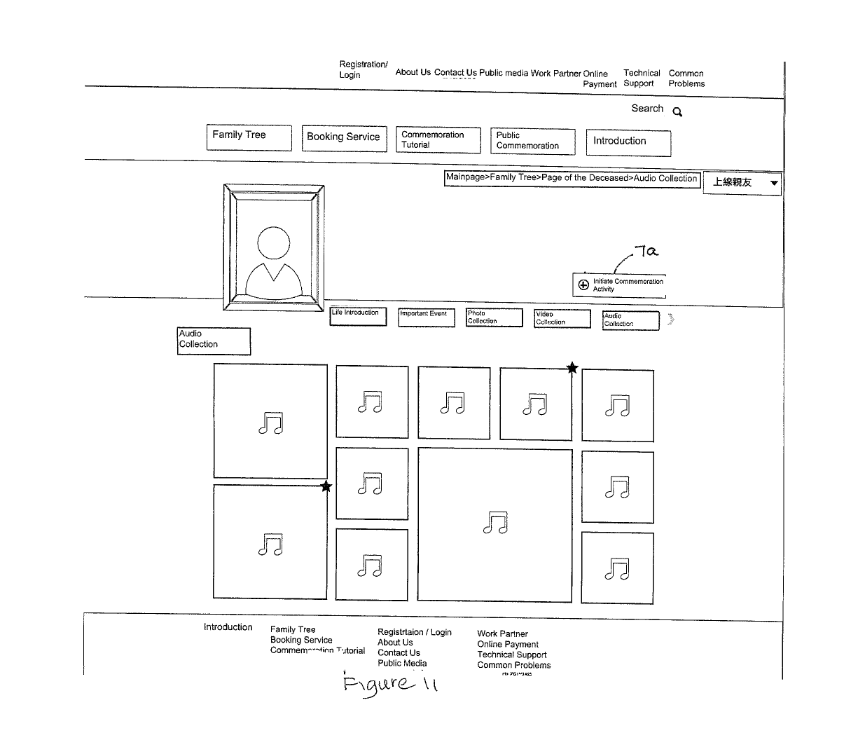

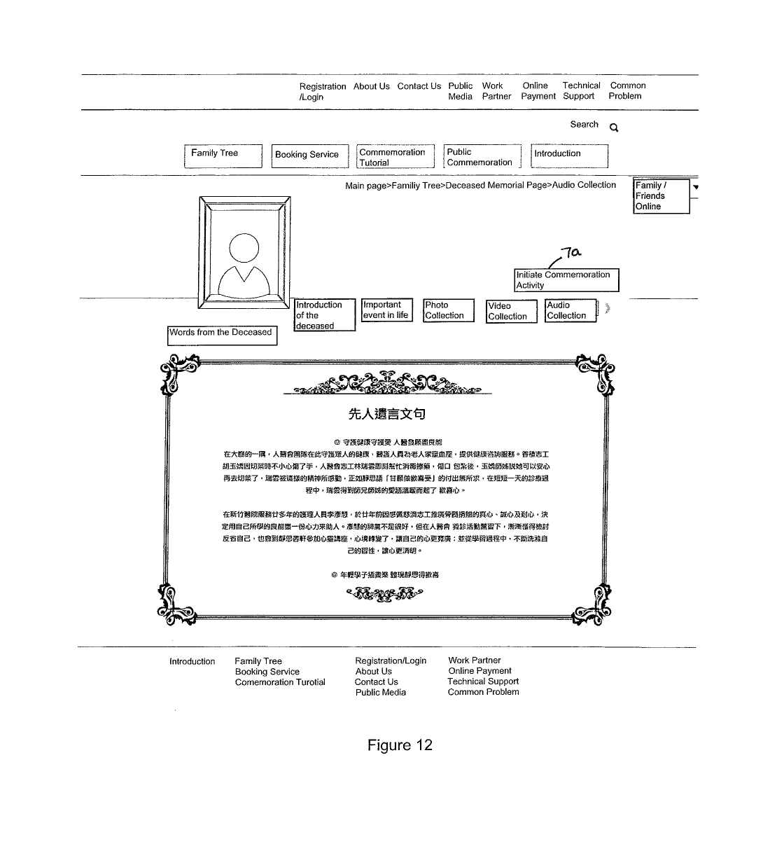

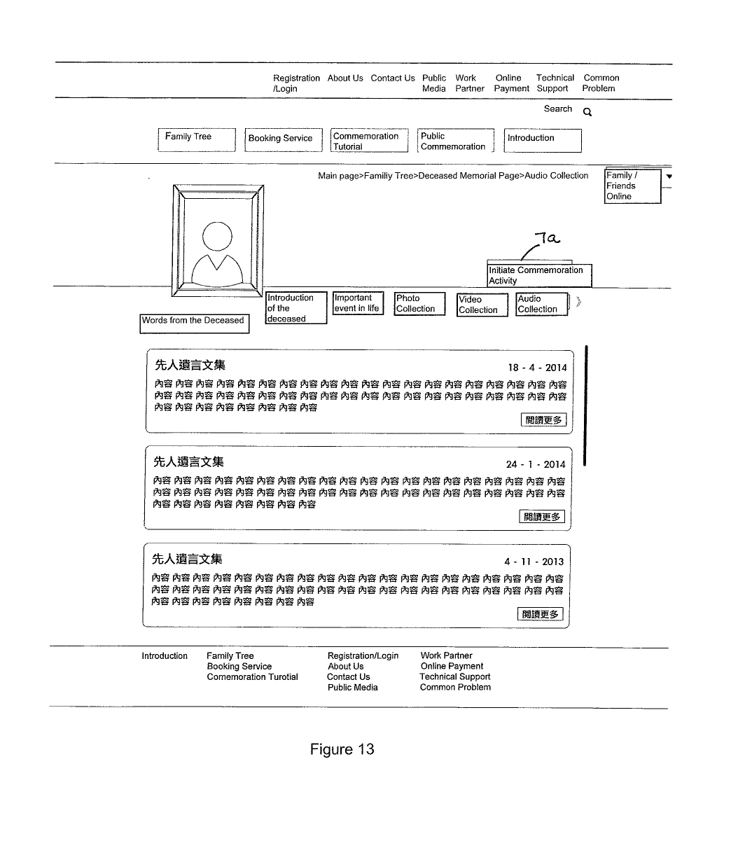

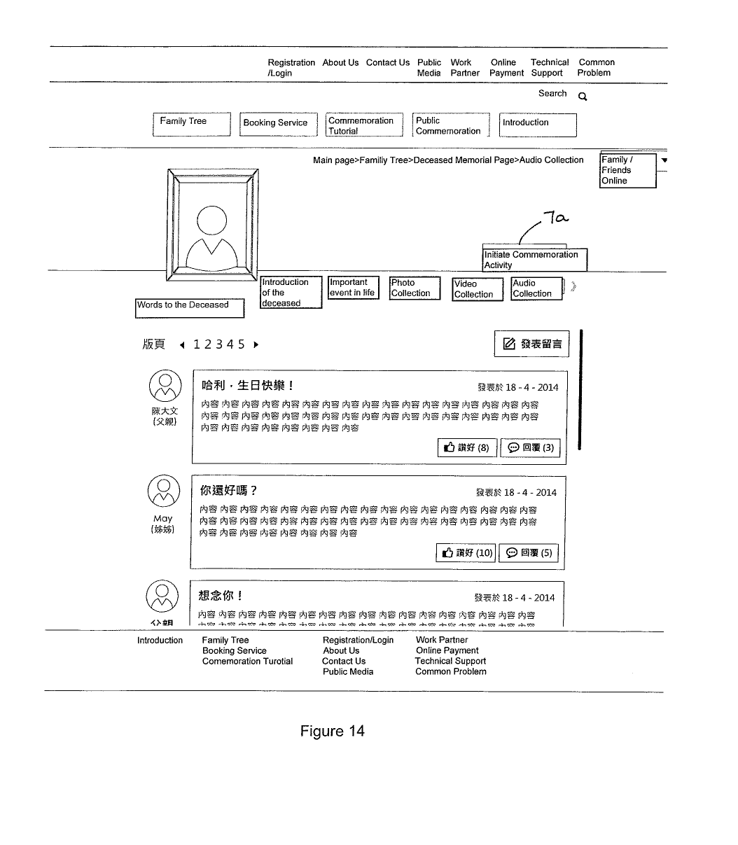

Details of the deceased are accessible by primary and secondary service account user through the data exchange platform as shown in FIGS. 7 to 12. The details include basic information of the deceased as in FIG. 7, images/photo albums as in FIG. 9, video and audio clips of the deceased as in FIGS. 10 and 11, a timeline showing lifetime events of the deceased as in FIG. 8, messages from the deceased to the living as in FIGS. 12 and 13 and messages from the primary and secondary service account users to the deceased as in FIG. 14. A list 5g of service account of users family to the deceased is provided in the window displaying information of the deceased as in FIGS. 7 and 9 to 14. The list is complied by the computer system including an icon and the name of the service account of user logged into the system.

It is also possible to set up gatherings for commemorating the deceased involving at least one primary service account user and another service account user, primary or secondary. The method involves the steps of requesting the computer system to set up a booking platform by clicking the provided button 7a for booking by a logged on service account of user. The button 7a is available in each of the pages in relation to the deceased as in FIGS. 7 to 14 except in the timeline as shown in FIG. 8.

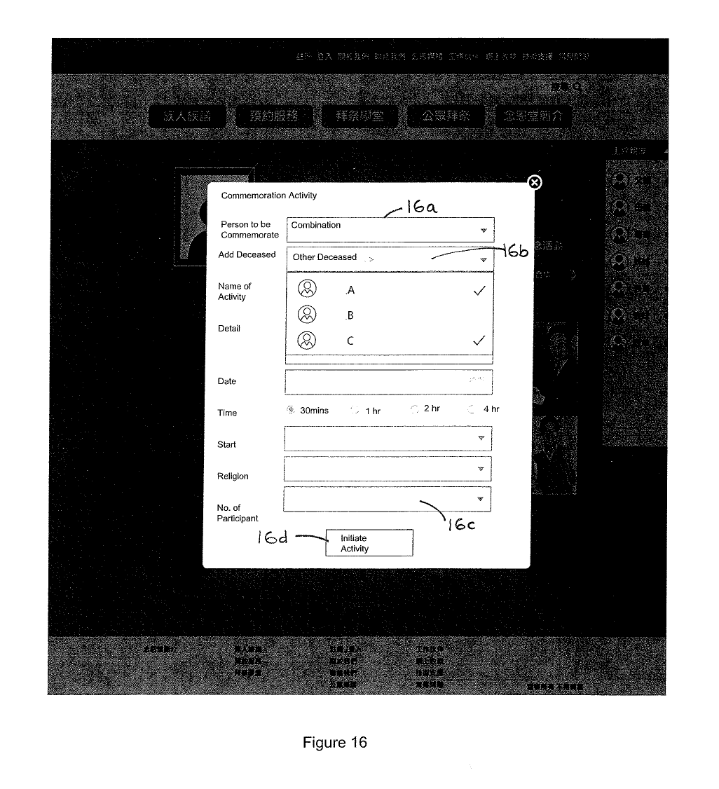

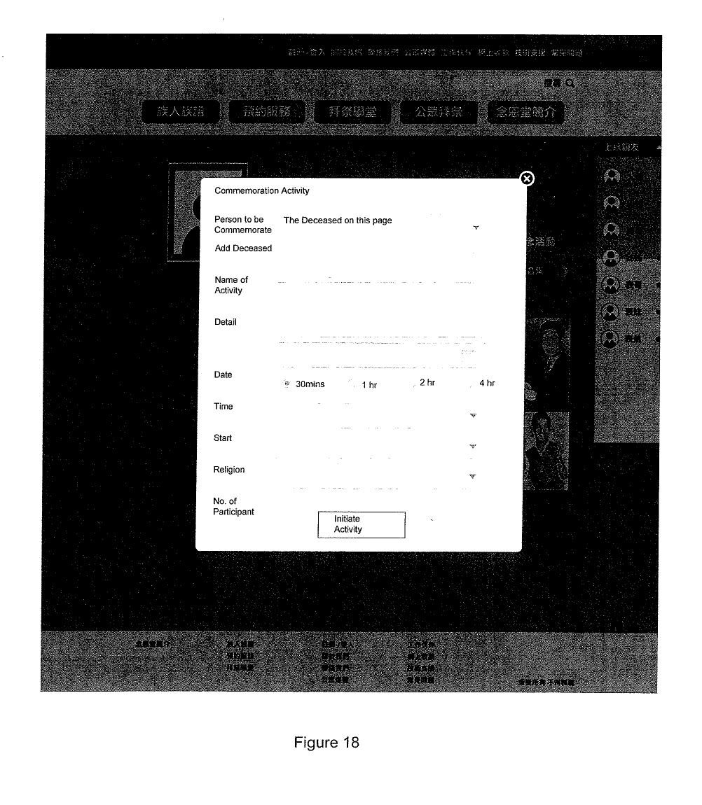

The method of setting up gatherings for commemorating the deceased involves receiving, by a computer system, instruction that a gathering commemoration is to be performed; creating, by the computer system, a temporary database having subset of contents of the data storage for storing information of the gathering and identifying the attendee relationship with the deceased, the primary/secondary service account user enters information of the gathering for creating a data exchange platform specific to the commemoration gather, this includes the information of the deceased to be commemorate, the date and time for the commemoration gathering and the information of the attendees as showed in FIGS. 16 to 18 creating, by the computer system, the data exchange platform; initiating, by the computer system, an invitation to service account of a user to enter the data exchange platform at a specified date and time; permitting access to the data exchange platform and the temporary database at the specified date and time for entering by the primary and secondary service account of users for manipulating the temporary database to performing intended commemoration operations.

It is also possible for initiating a gathering commemoration of two or more deceased with information stored in the data storage of the computer system as detailed in FIG. 16.

The method of doing so is generally the same as that for initiating a gathering commemoration of one deceased. One of the differences is that when creating the data exchange platform, it involves the step of creating at least two temporary databases having subset of contents of the data storage in relation to information of respective deceased person. It further includes the step of inviting two or more secondary service account of users to enter the data exchange platform.

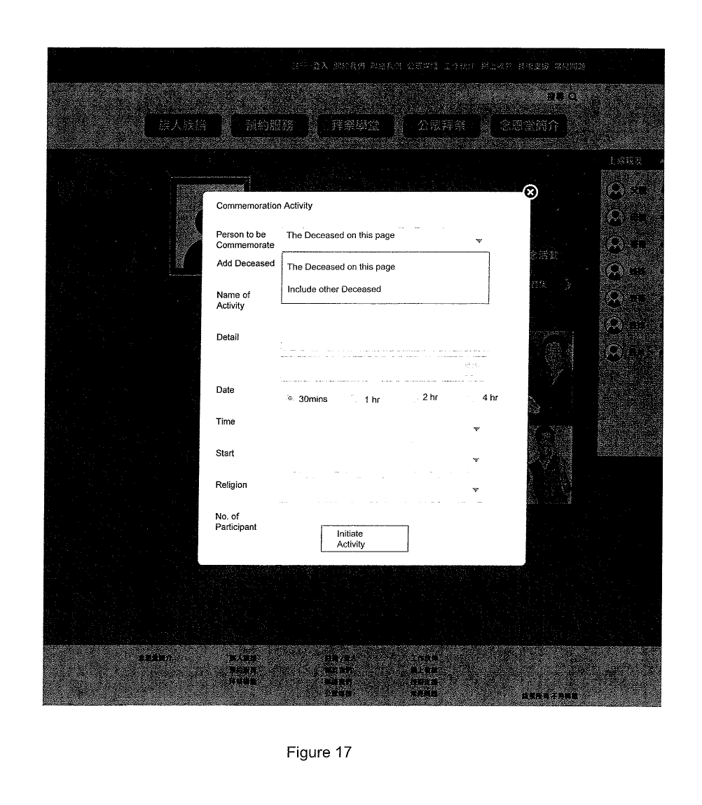

In more detail, as shown in FIG. 16, a form is generated upon request of the setting up of a gathering. In the space 16a and 16b, the service account of user may select the deceased(s) to be commemorated. Information of the deceased(s) must be pre-registered with the system. One or more of the deceased may be selected. The service account user is also required to provide information such as the name of the gathering, the date, the time, the starting time, the style of the commemoration ceremony and the number of participants as shown in FIGS. 16 and 17. At space 16c for entering the number of participant, instead of entering a number, it may be possible to provide a list of family member in a drop menu when the space 16c is clicked. The service account user setting up the gathering may decide to invite one or more of the family member in the list. Upon entering of all required information, the request may be sent to the system by pressing the button 16d, the request button. The computer system then creates the data exchange platform, initiating and sending invitations to the list of family member through channels preapproved by the respective family member, this may include sending a message to the member's phone if the phone number of the member is registered as a communication channel with the system

At the specific date and time, the invited service account of users shall log on to the computer system and enters the data exchange platform created for the gathering commemoration as shown in FIGS. 19 and 21. The family member may present gifts and offerings to the deceased by selecting from a list provided by the system. The selected gift/offering 19a and 21a will be presented and displayed on the data exchange platform display window as shown in FIGS. 19 and 21.

In a further aspect of this invention, there is provided a method of communication between the service accounts of users during the gathering commemoration. The method involves the steps of initiating, by the computer system, a chat session on the data exchange platform in response to a request to initiate a chat session between two or more chat accounts. A list of chat service accounts 19b and 21b is complied by and in response to a request by the primary service account of user. The chat accounts may be created for each of the service account of user before or at the same time as the list of chat service accounts is complied by the primary service account of user. If the chat service accounts are created before the compilation of the chat list, to compile the chat list would involve selecting a chat service account from the list of two or more chat service accounts.

The method further include monitoring, by the computer system, activities on the data exchange platform and the chat session. Information on the data exchange platform is displayed within a display window showing activities performed by one or more service account on the data exchange platform. Chat windows, real time video, real time audio or real time text message 19c, 19d, 21c, 21d are created on the data exchange platform for displaying the instant chats between each chat accounts indicating chats conducted between the two or more users.

Any information displayed in the display window of the data exchange platform is viewable through a third party computing device and is recordable upon request by the computing system.

Indicators may be assigned to each of the service account of user showing up on the data exchange platform for identification purpose and to indicate the presence of corresponding users.

The data exchange platform may be linked to a payment instrument for payment of any activity available and conducted by the service account of user. The computer system may contain information in relation to preset commemoration plans as shown in FIG. 21 for commemorating the deceased. A fixed price is assigned to each plan. The method of commemorating the deceased may involve the step of loading a list of commemoration plans, by the computer system, for selection by the service account of user upon request of the service account of the user. A plan may be selected and activities may be performed on the data exchange platform in accordance to a set of preset instructions assigned to the plan. The performance of activities is displayed in the display window of the data exchange platform. Payment by way of credit card may be available.

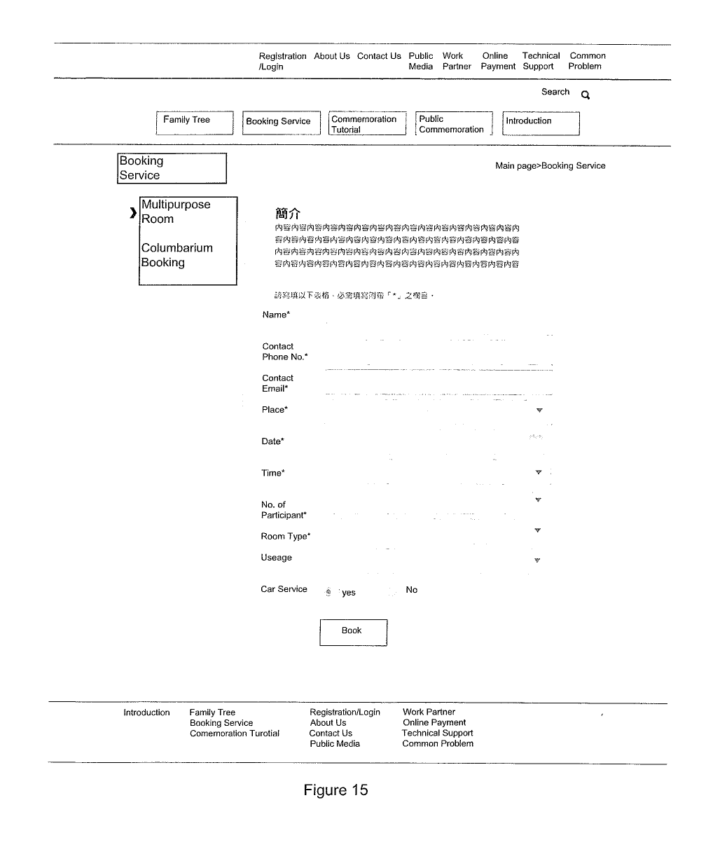

For setting up commemoration gathering, the system may offer booking of a physical room at a commemoration service centre in addition to the setting up of a data exchange platform. This is possible by sending a request to the computer system by completing a form generated by the computer system as shown in FIG. 15.

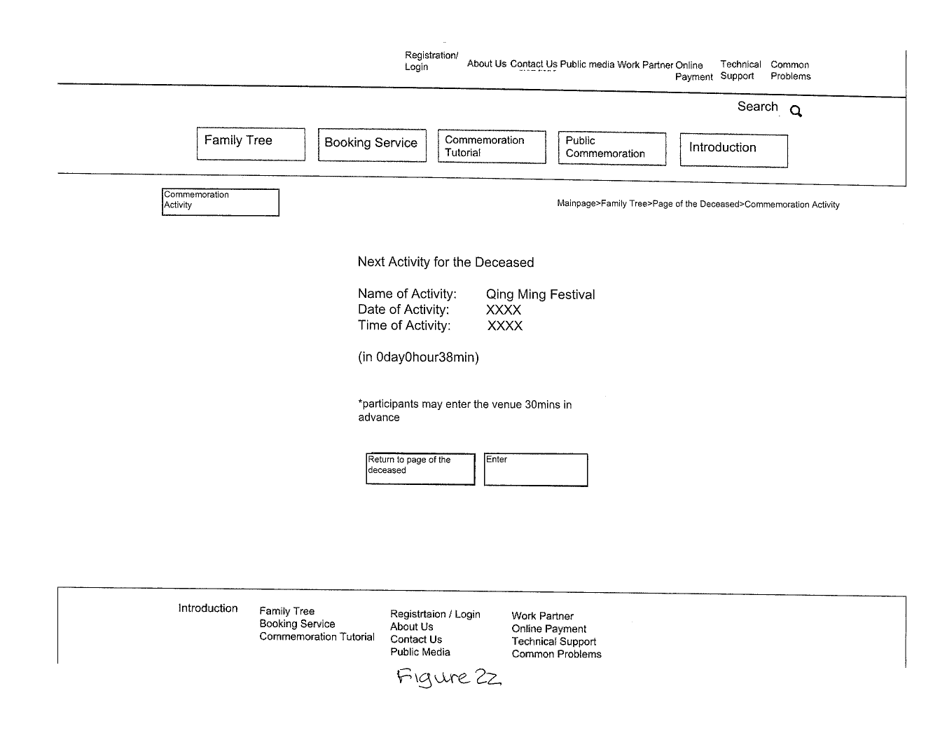

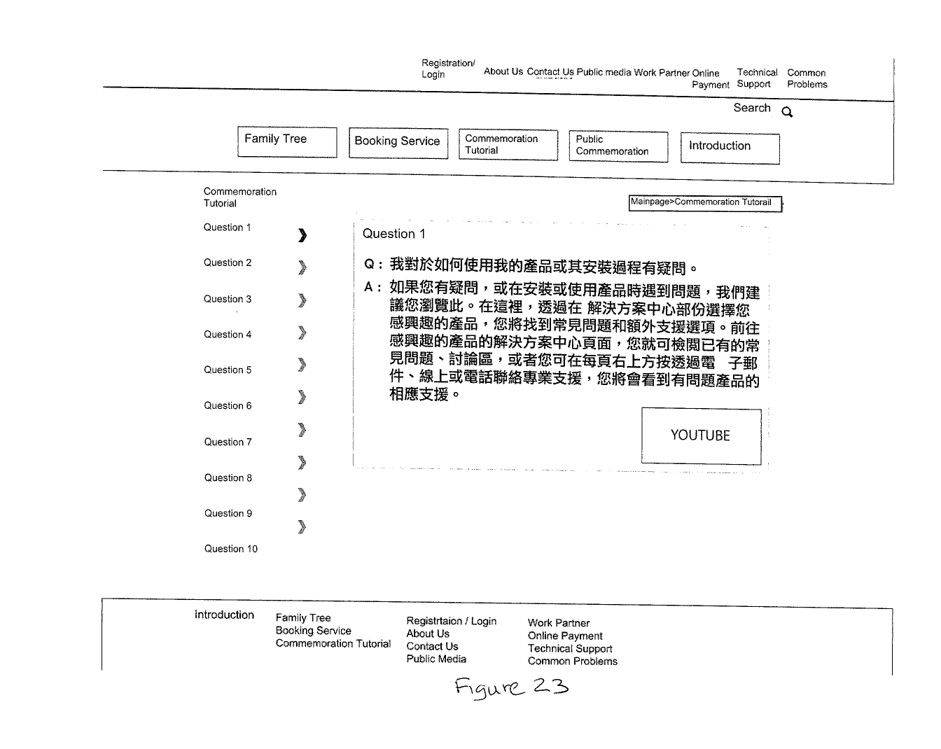

Also, a reminder is available to show details of a set up gathering for example by way of a pop up window. This is made available by the computer system to generate a display window as shown in FIG. 22 of the information of the gathering upon creating the data exchange platform for the gathering. The display window is opened when a service account user or an invited service account user logon to the system.

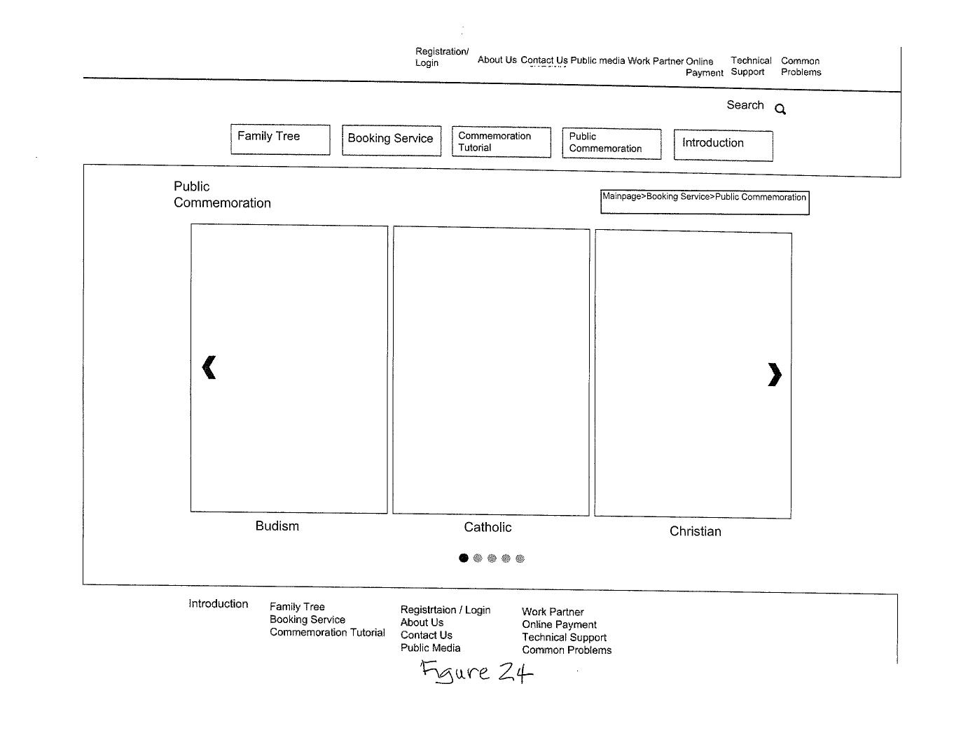

As shown in FIG. 24, commemoration of a public figure e.g. a religious idle is possible by the method as detailed above. The editing of the data exchange platform is only available to a primary service account of user. The information of the public figure may available to public or all account service user without need of logging on to the system. Or commemoration of the public figure is possible to all account service users only. As shown in FIG. 24, a scroll list of the religion which the public figure belongs is available for selection. In another embodiment of the invention, a list of the public figures may be available for selection. A data exchange platform is pre-created by the computer system. By selecting a particular public figure leads to a request for entering the pre-created data exchange platform of the public figure. Commemoration of the public figure is made possible through the data exchange platform.

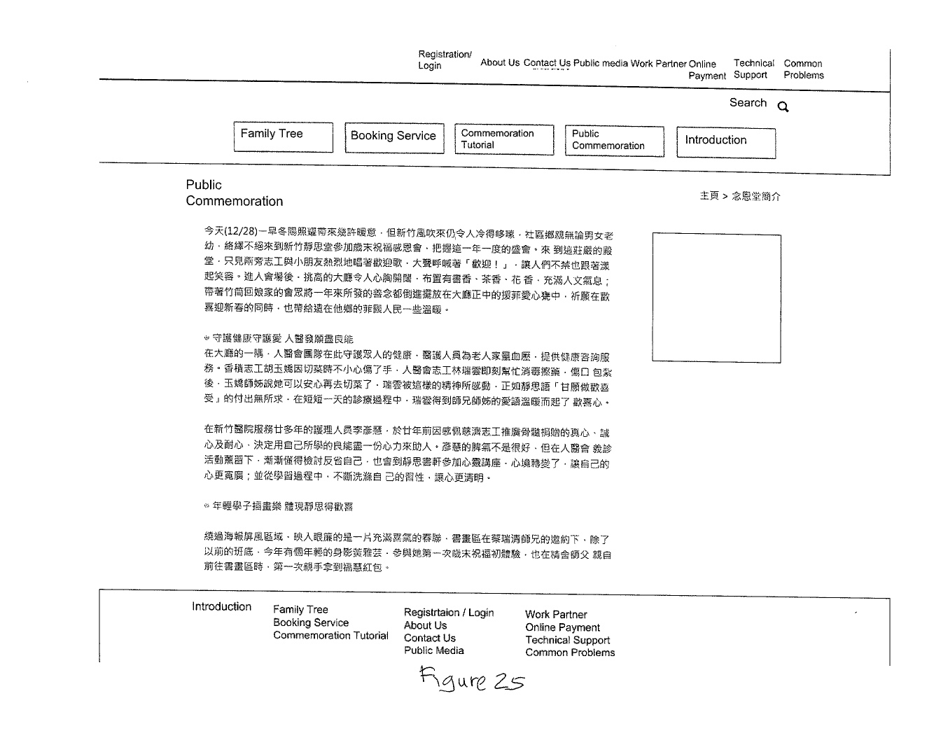

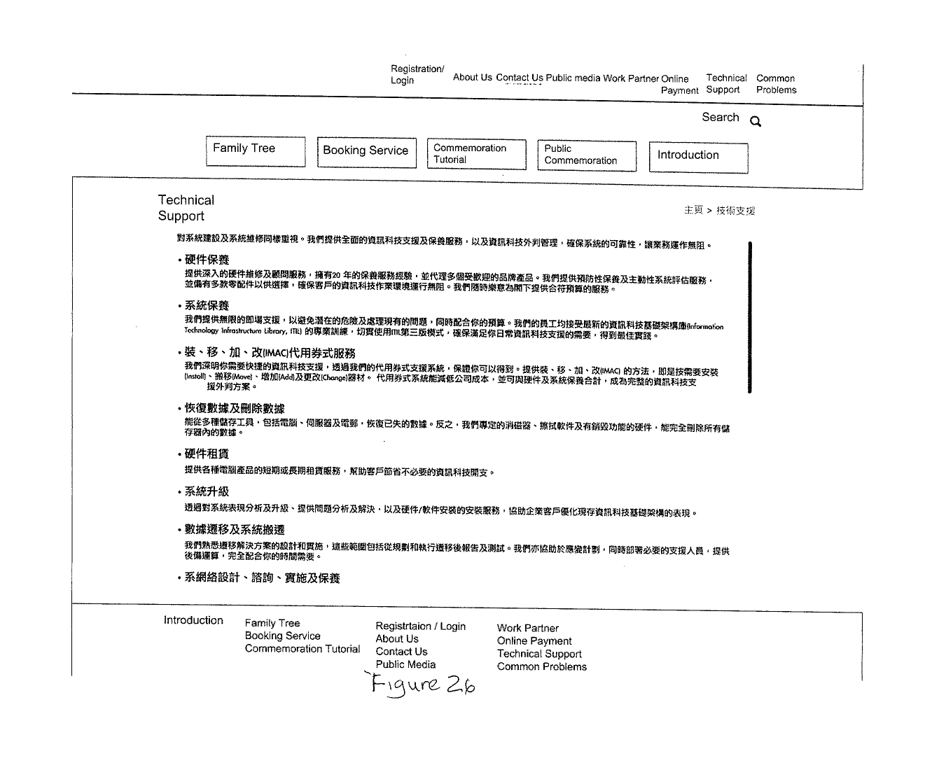

Other functions such as user guide, information of the computer system as shown in FIGS. 25 and 26 pre-entered into the system are available by clicking respective buttons on almost any display window/page entered by the service account user.

The invention has been given by way of example only, and various other modifications of and/or alterations to the described embodiment may be made by persons skilled in the art without departing from the scope of the invention as specified in the appended claims.

1. A method for commemoration of the deceased, comprising:
receiving, by a computer system, an instruction that specifies actions to be performed on a computer server to serve a request of a computing device;
creating, by the computer system, a temporary database having subset of contents of a data storage;
creating, by the computer system, a data exchange platform upon request by a service account of a user for manipulating the temporary database to perform intended commemoration operations;
translating, by the computer system, the instruction to a commemoration operation;
initiating, by the computer system, a chat session on the data exchange platform in response to a request to initiate a chat session between two or more chat accounts;
monitoring, by the computer system, activities on the data exchange platform and the chat session;
displaying, by the computer system, information on the data exchange platform within a display window showing activities performed by one or more service accounts on the data exchange platform; and
displaying, by the computer system, information within a chat window in the display window showing the chat session conducted between the two or more chat accounts on the data exchange platform;
wherein the method further comprising selecting a plan amongst a plurality of plans preset in the computing system, the preset plans contains instructions for performing specific actions on the data exchange platform and are displayed in the display window of the data exchange platform;
optionally, translating the instructions to a commemoration operation comprises mapping the instructions to a commemorating activity to be displayed in the display window;
optionally, the method further comprising compiling a list of chat service accounts in response to a request by the service account; and
optionally, the method further comprising selecting a chat service account from the list of two or more chat service accounts.

2. The method as claimed in claim 1, wherein the method further comprising recording information displayed within a display window on the data exchange platform.

3. The method as claimed in claim 1, wherein the method further comprising indicators assigned to indicate the presence of corresponding users.

4. The method as claimed in claim 1, wherein the method further comprising the step of customizing the computing device for providing instructions to the computer system specifying actions to be performed on the computer server to serve a request of the computing device;

5. The method as claimed in claim 1, wherein the chat session includes any one of real time video chat, real time audio chat and real time messaging.

6. A system for implementing the method as claimed in claim 1, the system comprising:
a processor,
an output device for displaying information
a memory communicatively connected with and readable by the processor and containing instructions that, when executed by the processor, cause the system to:
receiving, by a computer system, instruction that specify actions to be performed on a computer server to serve a request of a computing device;
creating, by the computer system, a temporary database having subset of contents of the data storage,
creating, by the computer system, a data exchange platform upon request by a service account of a user for manipulating the temporary database to performing intended commemoration operations,
translating, by the computer system, the instructions to a commemorating operation,
initiating, by the computer system, a chat session on the data exchange platform in response to a request to initiate a chat session between two or more chat accounts,
monitoring, by the computer system, activities on the data exchange platform and the chat session,
displaying, by the computer system, information on the data exchange platform within a display window indicating activities performed by one or more account on the data exchange platform,
displaying, by the computer system, information within a chat window in the display window indicating that the chat session is conducted between the two or more users.

7. The system as claimed in claim 6 further comprising an application installable to the computing device for customizing the computing device to provide instructions to the computer system specifying actions to be performed on the computer server to serve a request of the computing device

8. A method for commemoration of the deceased, comprising:
receiving, by a computer system, an instruction that specifies actions to be performed on a computer server to serve a request of a computing device;
creating, by the computer system, a temporary database having subset of contents of a data storage;
creating, by the computer system, a data exchange platform upon request by a service account of a first user;
translating, by the computer system, the instruction to a commemorating operation;
initiating, by the computer system, an invitation to a service account of a second user to enter the data exchange platform at a specified date and time,
permitting access to the data exchange platform and the temporary database at the specified date and time for entering by the service accounts of the first and second users for manipulating the temporary database to perform intended commemoration operations.

9. The method as claimed in claim 8, wherein the creation of a data exchange platform for performing intended commemoration operations, includes the step of creating at least two temporary databases having subset of contents of the data storage in relation to information of respective deceased person.

10. The method as claimed in claim 9, wherein the creation of the data exchange platform further includes the step of inviting two or more secondary service account of users to enter the data exchange platform.

11. The method as claimed in claim 8, wherein the method further comprising the steps of:
initiating, by the computer system, a chat session on the data exchange platform in response to a request to initiate a chat session by the primary or secondary service account of a user,
monitoring, by the computer system, activities on the data exchange platform and the chat session,
displaying, by the computer system, information on the data exchange platform within a display window indicating activities performed by one or more account on the data exchange platform,
displaying, by the computer system, information within a chat window in the display window indicating that the chat session is conducted between the two or more users.

12. A system for implementing the method as claimed in claim 8, the system comprising:
a processor,
an output device for displaying information;
a memory communicatively connected with an readable by the processor and containing instructions that, when executed by the processor, cause the system to:
receiving, by a computer system, instruction that specify actions to be performed on a computer server to serve a request of a computing device;
creating, by the computer system, a temporary database having subset of contents of the data storage,
creating, by the computer system, a data exchange platform upon request by a primary service account of a user,
translating, by the computer system, the instructions to an commemorating operation,
initiating, by the computer system, an invitation to secondary service account of a user to enter the data exchange platform at a specified date and time,
permitting access to the data exchange platform and the temporary database at the specified date and time for entering by the primary and secondary service account of users for manipulating the temporary database to performing intended commemoration operations.

13. A method of creating a family tree for remote commemoration of the deceased, comprising:
receiving, by a computer system, an instruction that specifies actions to be performed on a computer server to serve a request of a computing device;
creating, by the computer system, a temporary database having subset of contents of a data storage;
creating, by the computer system, a data exchange platform upon request by a service account of a user for manipulating the temporary database to perform intended commemoration operations;
translating, by the computer system, the instruction to an commemorating operation;
initiating, by the computer system, a family tree creating session on the data exchange platform in response to a request to initiate the family tree creating session by a service account;
providing, by the computer system, access to a data store of information corresponding to the deceased comprising a plurality of data nodes, each data node representing data relating to a corresponding one member of the family, and a plurality of edges, each edge defining a connection between a corresponding pair of the nodes;
determining, by the computer system, whether the connection between first and second nodes reflects a family relationship;
generating, by the computer system, an indicator for each connection reflecting a family relationship, the indicator being based on the family relationship relative to the deceased;
displaying, in an order according to the indicator, information of the corresponding member of the family; and
arranging, by the computer system, the nodes in a family tree, with the arranged nodes connected according to the family relationship between the arranged nodes.

14. The method as claimed in claim 13, wherein the data store of information corresponding to the deceased comprising a plurality of secondary data nodes, each secondary data node representing data relating to a corresponding one member of the family member direct to the member represented by a primary node being direct family member to the deceased, and a plurality of secondary edges, each secondary edge defining a connection between a corresponding pair of the secondary nodes.

15. The method as claimed in claim 13, wherein the determining whether the connection represents a family relationship and the step of generating an indicator are reach performed based on analyzing and providing a weight to one or more of the following factors:
a match of surnames between users corresponding to the node and any one of the secondary node;
a match of a surname to middle name between users corresponding to the node and any one of the secondary node;
gender of users corresponding to the node and any one of the secondary node, and
relative ages of users corresponding to the node and any one of the secondary node.

16. The method as claimed in claim 13, further comprising the steps of:
receiving, by a computer system, an instruction from an account user to redefine each edge between a corresponding pair of the nodes based on the family relationship in relation to the account user;
creating, by the computer system, a temporary database having subset of contents of a data storage;
providing, by the computer system, access to the temporary database with information corresponding to the user comprising a plurality of data nodes, each data node representing data relating to a corresponding one member of the family to the user, and a plurality of edges, each edge defining a connection between a corresponding pair of the nodes;
re-determining, by the computer system, whether the connection between first and second nodes reflects a family relationship to the user;
re-generating, by the computer system, an indicator for each connection reflecting a family relationship, the indicator being based on the family relationship relative to the account user;
displaying, in an order according to the indicator, information of the corresponding member of the family; and
arranging, by the computer system, the nodes in a family tree, with the arranged nodes connected according to the family relationship between the arranged nodes.

17. The method as claimed in claim 13, further comprising the steps of:
receiving, by a computer system, an instruction from an account user to selectively display a set of information in the family tree which relates to a particular bloodline;
determining, by the computer system, whether each of the nodes reflects a family relationship in relation to a particular bloodline;
creating, by the computer system, a temporary database containing the nodes that reflect a family relationship in relation to a particular bloodline and a plurality of edges, each edge defining a connection between a corresponding pair of the nodes;
re-generating, by the computer system, an indicator for each connection reflecting a family relationship, the indicator being based on the family relationship relative to the account user or the deceased;
displaying, in an order according to the indicator, information of the corresponding member of the family; and
arranging, by the computer system, the nodes in a family tree, with the arranged nodes connected according to the family relationship between the arranged nodes.

18. The method as claimed in claim 17, wherein the blood line comprises the father's blood line and/or the mother's blood line.

19. The method as claimed in claim 13, wherein the family tree comprises a genealogy record.

20. A system for implementing an interactive display of a family tree with family members and relationships between family members, the system comprising:
a processor,
a memory communicatively connected with an readable by the processor and containing instructions that, when executed by the processor, cause the system to
creating, by the computer system, a temporary database having subset of contents of the data storage,
creating, by the computer system, a data exchange platform upon request by a service account of a user for manipulating the temporary database to performing intended commemoration operations,
translating, by the computer system, the instructions to an commemorating operation,
initiating, by the computer system, a family tree creating session on the data exchange platform in response to a request to initiate the family tree creating session by a service account,
providing, by the computer system, access to a data store of information corresponding to the deceased comprising a plurality of data nodes, each data node representing data relating to a corresponding one member of the family, and a plurality of edges, each edge defining a connection between a corresponding pair of the nodes,
determining, by the computer system, whether the connection between first and second nodes reflects a family relationship,
generating, by the computer system, an indicator for each connection reflecting a family relationship, the indicator is based on the family relationship relative to the deceased,
displaying, in an order according to the indicator, information of the corresponding member of the family,
arranging, by the computer system, the nodes in a family tree, with the arranged nodes connected according to the family relationship between the arranged nodes.
